(19) United States
(12) Patent Application Publication
(10) Pub. No.: US 2025/0227270 A1
(43) Pub. Date: Jul. 10, 2025

(54) ENCODING METHOD, DECODING METHOD, ENCODING APPARATUS, DECODING APPARATUS, ELECTRONIC DEVICE, AND STORAGE MEDIUM

(71) Applicant: Douyin Vision Co., Ltd., Beijing (CN)

(72) Inventors: He WANG, Beijing (CN); Dejun Zhang, Beijing (CN); Jiawei Jiang, Beijing (CN); Ziqian Wu, Beijing (CN); Kunpeng Lin, Beijing (CN)

(21) Appl. No.: 19/094,726

(22) Filed: Mar. 28, 2025

Related U.S. Application Data
(63) Continuation of application No. PCT/CN2023/122433, filed on Sep. 28, 2023.

(30) Foreign Application Priority Data
Sep. 29, 2022 (CN) 202211204797.8

(51) Int. Cl. H04N 19/30; H04N 19/184; H04N 19/40

(52) U.S. Cl. CPC H04N 19/30; H04N 19/184; H04N 19/40

(57) ABSTRACT

The embodiments of the disclosure provide an encoding method, a decoding method, an encoding apparatus, a decoding apparatus, an electronic device and a storage medium. The encoding method includes: encoding a current media frame into at least two bitstreams; and generating a target bitstream of the current media frame, wherein the target bitstream includes coded data and padding data, the coded data includes a first bitstream, the first bitstream is one of the at least two bitstreams, and the padding data includes at least one of other bitstreams except the first bitstream, bitstreams of historical media frames, or enhanced coding information of the current media frame.

### CROSS-REFERENCE TO RELATED APPLICATIONS

This application is a continuation of the PCT application No. PCT/CN2023/122433 filed on Sep. 28, 2023, which is based on and claims benefit to Chinese Patent Application No. 202211204797.8 filed on Sep. 29, 2022. The entire disclosures of the prior applications are hereby incorporated by reference in their entireties.

### TECHNICAL FIELD

Embodiments of the present disclosure relate to encoding and decoding technologies, and in particular, to an encoding method, a decoding method, an encoder, a decoder, an electronic device, and a storage medium.

### BACKGROUND

With the development of technologies, users have higher and higher requirements for audio quality in real-time communication, and the related codecs cannot meet the high-quality requirements of the users, which requires that service providers upgrade the audio codecs to improve the quality of the encoded audio.

However, not all users will upgrade to a new version of encoder, and there will always be a situation where new and old versions coexist, and in order to enable an old terminal to still use an old version of codec for communication, it is necessary to ensure compatibility between the new and old versions of codec.

The related method for processing the compatibility problem of the old and new encoders comprises transcoding and fallback, where transcoding has problems of increasing the computational complexity and end-to-end delay, and fallback has a problem of degrading the communication quality. Therefore, how to ensure the compatibility between the new encoder and the old decoder without causing additional end-to-end delay and degradation of communication quality is a technical problem to be solved.

### SUMMARY

The present disclosure provides an encoding method, a decoding method, an encoder, a decoder, an electronic device, and a storage medium, to ensure compatibility between the new encoder and the old decoder without causing additional end-to-end delay and degradation of communication quality.

In a first aspect, an embodiment of the present disclosure provides an encoding method, comprising:
encoding a current media frame into at least two bitstreams; and
generating a target bitstream of the current media frame, wherein the target bitstream comprises encoded data and padding data, the encoded data comprises a first bitstream, the first bitstream is one of the at least two bitstreams, and the padding data comprises at least one of bitstream(s) other than the first bitstream, bitstreams of historical media frames, or enhanced coding information of the current media frame.

In a second aspect, an embodiment of the present disclosure further provides a decoding method, comprising:
obtaining a target bitstream of a current media frame, wherein the target bitstream comprises encoded data and padding data, the encoded data comprises a first bitstream, the first bitstream is one of at least two bitstreams of the current media frame, and the padding data comprises at least one of bitstream(s) other than the first bitstream, bitstreams of historical media frames, or enhanced coding information of the current media frame; and
decoding the target bitstream, to obtain the current media frame.

In a third aspect, an embodiment of the present disclosure provides an encoding apparatus, comprising:
an encoding module, configured to encode a current media frame into at least two bitstreams; and
an generating module, configured to generate a target bitstream of the current media frame, wherein the target bitstream comprises encoded data and padding data, the encoded data comprises a first bitstream, the first bitstream is one of the at least two bitstreams, and the padding data comprises at least one of bitstream(s) other than the first bitstream, bitstreams of historical media frames, or enhanced coding information of the current media frame.

In a fourth aspect, an embodiment of the present disclosure provides a decoding apparatus, comprising:
an obtaining module, configured to obtain a target bitstream of a current media frame, wherein the target bitstream comprises encoded data and padding data, the encoded data comprises a first bitstream, the first bitstream is one of at least two bitstreams of the current media frame, and the padding data comprises at least one of bitstream(s) other than the first bitstream, bitstreams of historical media frames, or enhanced coding information of the current media frame; and
a decoding module, configured to decode the obtained target bitstream, to obtain the current media frame.

In a fifth aspect, an embodiment of the present disclosure further provides an electronic device, comprising:
one or more processing means; and
   a storage means, configured to store one or more programs, which when executed by the one or more processing means, cause the one or more processing means to implement the encoding method or decoding method as provided by the embodiments of the present disclosure.

In a sixth aspect, an embodiment of the present disclosure further provides a storage medium containing computer-executable instructions, which when executed by a computer processor, perform the encoding method or decoding method as provided by the embodiments of the present disclosure.

### BRIEF DESCRIPTION OF THE DRAWINGS

The above and other features, advantages, and aspects of the embodiments of the present disclosure will become more apparent by referring to the following DETAILED DESCRIPTION when taken in conjunction with the accompanying drawings. Throughout the drawings, the same or similar reference numbers refer to the same or similar elements. It should be understood that the drawings are schematic and that elements and components are not necessarily drawn to scale.

FIG. 1a is a schematic flowchart of an encoding method provided in an embodiment of the present disclosure;

FIG. 1b is a schematic diagram of a bitstream structure of an Opus encoder provided in an embodiment of the present disclosure;

FIG. 2 is a schematic flowchart of another encoding method provided in an embodiment of the present disclosure;

FIG. 3a is a schematic flowchart of a decoding method provided in an embodiment of the disclosure;

FIG. 3b is a schematic flowchart of another decoding method provided in an embodiment of the disclosure;

FIG. 4a is a schematic flowchart of yet another decoding method provided in an embodiment of the present disclosure;

FIG. 4b is a schematic encoding flowchart of an encoding method provided in an embodiment of the present disclosure;

FIG. 4c is a schematic diagram illustrating a bitstream entering and exiting a cache region, provided in an embodiment of the present disclosure;

FIG. 4d is a schematic diagram illustrating another bitstream entering and exiting a cache region, provided in an embodiment of the disclosure;

FIG. 4e is a schematic diagram of a bitstream format provided in an embodiment of the disclosure;

FIG. 4f is a schematic encoding flowchart for an Opus encoder provided in an embodiment of the present disclosure;

FIG. 4g is a schematic diagram of a bitstream structure for an Opus encoder provided in an embodiment of the present disclosure;

FIG. 4h is a schematic decoding flowchart of a decoder provided in an embodiment of the present disclosure;

FIG. 4i is a schematic decoding flowchart provided in an embodiment of the disclosure;

FIG. 4j is a schematic packing diagram provided in an embodiment of the present disclosure;

FIG. 4k is a schematic diagram of a bitstream structure provided in an embodiment of the present disclosure;

FIG. 4l is another schematic packing diagram provided in an embodiment of the present disclosure;

FIG. 4m is a schematic diagram of yet another bitstream structure provided in an embodiment of the disclosure;

FIG. 5 is a schematic structural diagram of an encoding apparatus provided in an embodiment of the present disclosure;

FIG. 6a is a schematic structural diagram of a decoding apparatus provided in an embodiment of the present disclosure;

FIG. 6b is a schematic structural diagram of another decoding apparatus provided in an embodiment of the present disclosure;

FIG. 7 is a schematic structural diagram of an electronic device provided in an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but rather are provided for a more complete and thorough understanding of the present disclosure. It should be understood that the drawings and the embodiments of the present disclosure are for illustration purposes only and are not intended to limit the scope of the present disclosure.

It should be understood that the various steps recited in method embodiments of the present disclosure may be performed in a different order, and/or performed in parallel. Moreover, the method embodiments may include additional steps and/or omit performing the illustrated steps. The scope of the present disclosure is not limited in this respect.

The term “include” and variations thereof as used herein are intended to be open-ended, i.e., “including but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the following description.

It should be noted that the terms “first”, “second”, and the like in the present disclosure are only used for distinguishing different devices, modules or units, and are not used for limiting the order or interdependence of the functions performed by the devices, modules or units.

It is noted that references to “a” or “an” in this disclosure are intended to be illustrative rather than limiting, and that those skilled in the art will appreciate that it should be understood as “one or more” unless the context clearly indicates otherwise.

The names of messages or information exchanged between devices in the embodiments of the present disclosure are for illustrative purposes only, and are not intended to limit the scope of the messages or information.

It is understood that, before the technical solutions disclosed in the embodiments of the present disclosure are used, the user should be informed of the type, use range, use scene, etc. of the personal information related to the present disclosure in a proper manner according to relevant laws and regulations and the authorization of the user is obtained.

For example, in response to receiving a user's active request, a prompt message is sent to the user to explicitly prompt the user that the requested operation to be performed would require acquisition and use of personal information to the user. Thus, the user can autonomously select whether to provide personal information to software or hardware such as an electronic device, an application, a server, or a storage medium that performs the operations of the technical solution of the present disclosure, according to the prompt message.

As an alternative but non-limiting implementation, in response to receiving an active request from the user, the manner of sending the prompt message to the user may be, for example, a pop-up window, and the prompt message may be presented in a text manner in the pop-up window. In addition, a selection control for the user to select to “agree” or “disagree” to provide personal information to the electronic device, can be carried in the pop-up window.

It is understood that the above informing and user authorization process is only illustrative and is not intended to limit the implementation of the present disclosure, and other ways of satisfying the relevant laws and regulations may be applied to the implementation of the present disclosure.

It will be appreciated that the data referred to in this disclosure, including but not limited to the data itself, the acquisition or use of the data, should comply with the requirements of the applicable laws and regulations and related provisions.

The related methods for processing the compatibility problem of the old and new encoders are transcoding and fallback.

Transcoding refers to the conversion of a compressed coded media bitstream from one format to another, which is essentially a process of first decoding and then encoding. In real-time communication, transcoding of media bitstreams generally occurs at a server, and when a new terminal (i.e., a terminal that operates a new encoder) and an old terminal (i.e., a terminal that operates a set encoder) communicates together, a server with a transcoding function will transcode media bitstreams sent by the new terminal into a format decodable by the old terminal, to ensure normal communication between the new and old terminals, but adding a transcoding module at the media server will increase the computational complexity and end-to-end delay, and the transcoded audio quality is degraded to a certain extent.

Fallback refers to that when a new terminal and an old terminal communicate together, the new version terminal will fall back to the old version, and an encoder which can be supported by the old terminal is used, so that the old terminal can decode media bitstreams sent by the new terminal, without introducing additional overhead. However, when a plurality of new terminals communicate, if an old terminal joins the communication, all the new terminals will be fallen back to the old version, so that the new terminals cannot use characteristics of the new version encoder, affecting the user experience; meanwhile, a fallback command received by the new terminal may have a certain delay, so that the old terminal cannot decode the media bitstreams sent by the new terminal within this period of time.

In real-time communication, continuity of audio signals is also an important indicator of attention of a user. When network conditions are poor, more data packets are lost, and if the codec is poor in packet loss resistance, a complete audio signal cannot be recovered when packet loss occurs, so that the sound heard by the user will be frozen, affecting the communication experience of the user. Multiple Description Coding (MDC) is a technical means for improving the resistance of codecs to network packet loss.

The MDC divides a media bitstream into a plurality of sub-media bitstreams for encoding, which are transmitted using different data links (network paths). Packet loss conditions of different data links are irrelevant. By taking audio encoding as an example, a receiving end can decode audio with acceptable quality when receiving one of the media bitstreams, and can decode audio with higher quality when receiving a plurality of media bitstreams, which can greatly improve packet loss resistance of an encoder. However, media bitstreams are sent out after being encapsulated by RTP (Real-time Transport Protocol), and sending a plurality of media bitstreams simultaneously will bring more RTP header overhead, so that when the network bandwidth is limited, the bit rate actually allocated to the encoder is reduced, and the encoded voice quality is reduced. In addition, the bitstream sending scheme used by the encoder of the existing old terminal is basically a single bitstream scheme. To implement the compatibility with the old terminal when sending a plurality of media bitstreams by MDC, a large amount of adaptations and modifications are required at the media server, increasing the upgrade cost.

In order to solve the above technical problem, an embodiment of the present disclosure provides an encoding method, comprising: encoding a current media frame into at least two bitstreams; and generating a target bitstream of the current media frame, wherein the target bitstream comprises encoded data and padding data, the encoded data comprises a first bitstream, the first bitstream is one of the at least two bitstreams, and the padding data comprises at least one of bitstream(s) other than the first bitstream, bitstreams of historical media frames, or enhanced coding information of the current media frame.

FIG. 1a is a schematic flowchart of an encoding method provided in an embodiment of the present disclosure. The embodiment of the present disclosure is suitable for a situation where a target bitstream compatible with a set encoder is generated without additional end-to-end delay and degradation of communication quality. The method may be executed by an encoding apparatus. The apparatus may be implemented in a form of software and/or hardware, and optionally, implemented by an electronic device. The electronic device may be a mobile terminal, a PC terminal, or a server. As shown in FIG. 1a, the method comprises: S110, encoding a current media frame into at least two bitstreams. In some embodiments, the at least two bitstreams are multiple description bitstreams.

In the step of encoding, a encoding method of a set encoder required to be compatible with can be adopted, and the set encoder can be the encoder required to be compatible with. The encoding method is not limited in this step, as long as it is ensured that a set decoder can decode a plurality of bitstreams (such as multiple description bitstreams). The number of the current plurality of bitstreams is n, and n is a positive integer greater than or equal to 2.

The present disclosure adopts the same encoding mode as the set encoder to encode the current media frame, which can ensure that the bitstream obtained by the encoding can be decoded by the set encoder, and ensure the compatibility of the encoder that executes the encoding with the set encoder. The current media frame may be considered to be a media frame currently to be encoded, such as an audio frame, a video frame, and/or an image. The current multiple description bitstream can be regarded as a bitstream with a multiple description technical characteristic, obtained by encoding the current media frame.

The encoder that executes the encoding in the present disclosure may be considered as a new encoder. The new encoder may be considered as a new version of encoder, and may be an updated encoder based on the set encoder. The set encoder is not limited here, and it may be a single bitstream encoder, such as an encoder including a padding data portion, e.g., an Opus encoder.

FIG. 1b is a schematic diagram of a bitstream structure of an Opus encoder provided in an embodiment of the present disclosure. Referring to FIG. 1b, the bitstream structure of the Opus encoder is composed of a frame header byte, a padding data total length byte, in-band Forward Error Correction (FEC) data, encoded data, and padding data. The frame header byte carries attributes of an audio frame (frame length, coded bandwidth, channel number, and the like), a flag bit indicating variable rate coding or not, and a flag bit indicating whether padding data is carried or not in the bitstream; the in-band FEC data is redundant encoded data of a previous frame of audio signal; the encoded data is core encoded data of a current frame of audio signal; the padding data is a byte padded to ensure that a total bitstream length of each frame is the same; in decoding, whether the padding data is carried or not is decoded first from the frame header byte, and if the padding data is carried, the total length of the padding data is decoded, and data in the padding portion is filtered out according to the total length, and only core encoded data or in-band FEC data is decoded.

Since the Opus encoder performs in-band FEC encoding on the signal, the signal has a certain packet loss resistance, when a data packet of the current frame is lost but a data packet of the next frame is received, the in-band FEC data carried in the next frame can be used for decoding and outputting the current frame of audio signal, but when the data packet of the next frame is also lost, the normal signal cannot be decoded and output, resulting in a freeze phenomenon. In order to solve the problem, the present disclosure encodes the current media frame into a plurality of current multiple description bitstreams by using the encoding mode of the set encoder, and introduces the Multiple Description Coding MDC technology on the basis of the Opus encoder, thereby improving the packet loss resistance of the encoder.

In the step, Multiple Description Coding is introduced on the basis of the Opus encoder, that is, the encoding mode of the set encoder is adopted, to encode the current media frame to obtain a plurality of current multiple description bitstreams. Each current multiple description bitstream is independent of each other and complementary with each other, and n is a positive integer greater than or equal to 2. Each current multiple description bitstream can be a different bitstream that is generated by subjecting to the coding method of the set encoder, the current media frame can be recovered by one current multiple description bitstream, and the current media frame with better quality can be recovered by the plurality of current multiple description bitstreams.

The Multiple Description Coding encoding method is to encode the current media frame into a plurality of bitstreams (i.e., descriptions) and to recover the current media frame with acceptable quality from each description. The quality of the recovered media, image or audio only depends on the number of descriptions, that is, if the decoder receives more descriptions, the higher the quality of the current media frame formed by these descriptions together.

The encoding method of the set encoder adopted in this step may include using a quantization mode, such as a Noise Shaping Quantizer (NSQ) quantization mode, of the set encoder, and then packing the quantized signal into a target bitstream, so as to ensure compatibility between the new encoder and the set encoder. In the present disclosure, packing can be made also with reference to the bitstream format of the set encoder, so that the compatible portions in the present disclosure can be decoded by the set encoder, for example, packing the first bitstream into a location compatible with a encoded data portion of the set encoder, and encoding the second bitstream into (“encoding into” in the present disclosure may be understood as “writing”) a location compatible with a padding data portion of the set encoder. Compatibility may be embodied in that after packing into the corresponding location, the set encoder can obtain and decode a bitstream. The encoded data portion of the target bitstream may be compatible with the encoded data portion of the set encoder, e.g., at the same location of the bitstream.

In one embodiment, the first bitstream is encoded into the encoded data portion and the second bitstream is encoded into the padding data portion or the in-band FEC data portion, in the bitstream format of the set encoder.

When encoding to obtain the current multiple description bitstream in the step, a plurality of multiple description signals of a sample can be obtained based on the sample in the current media frame, the plurality of multiple description signals can all be a signal to be quantized, that is characterized by the sample in the current media frame, and each multiple description signal is encoded in the same encoding mode as the set encoder, to obtain the current multiple description bitstream. When the multiple description signal is encoded, the same quantization mode as the set encoder can be adopted to generate the current multiple description bitstream. The current media frame may consist of a plurality of samples.

The encoding method further comprises: step S130, generating a target bitstream of the current media frame.

The target bitstream may be considered as a bitstream obtained after the current media frame is encoded. The target bitstream comprises encoded data and padding data. The encoded data includes a first bitstream. The first bitstream is one of the at least two bitstreams. The first bitstream is a current bitstream in n bitstreams. The first bitstream may be any one of the at least two bitstreams.

The bitstreams can be selected in sequence in a form of a queue. The sequencing of the current multiple bitstreams in the queue is not limited, and can be determined based on a sequence obtained by the encoding.

The first bitstream may be stored to the encoded data portion of the target bitstream.

The padding data comprises at least one of bitstream(s) other than the first bitstream, bitstreams of historical media frames, or enhanced coding information of the current media frame.

In some embodiments, bitstreams of historical media frames comprise one of at least two bitstreams of at least one historical media frame. For example, when there is a historical media frame before the current media frame, the target bitstream includes the second bitstream.

The number of the target bitstreams is one. One target bitstream is generated by encoding one current media frame. In the present disclosure, a plurality of bitstreams are carried in the form of a single bitstream. The bitstream format of the target bitstream is the same as that of the set encoder, the set encoder can decode the target bitstream after obtaining the target bitstream, the set encoder is an encoder with a data padding portion, and the set encoder can be a single bitstream encoder, namely an encoder outputting a single bitstream, such as an Opus encoder.

In some embodiments, the targeted bitstream is an Opus bitstream.

The bitstream format of the target bitstream is the same as that of the set encoder, and the target bitstream can comprise an encoded data portion and a padding data portion. In the bitstream format of FIG. 1b, the padding data portion may be regarded as a padding portion, and remaining portions except the padding data portion may be regarded as compatible portions compatible with the set encoder. The compatible portions can be decoded by a set decoder corresponding to the set encoder. The compatible portions include, in addition to the encoded data portion, in-band FEC data, padding total length byte and frame header byte. The position of the in-band FEC data portion of a different set encoder is different, and is not limited herein.

In one embodiment, fields of the target bitstream are a frame header byte, a padding data total length byte, in-band FEC data, encoded data, and padding data in sequence. The byte occupied by each field is not specified here. The frame length of each target bitstream may be equal. The padding data and the padding data total length byte can be optional in the target bitstream. The field corresponding to the “optional” identifier in the figures of the present disclosure may be an optional field.

In this step, when the target bitstream is generated, the first bitstream may be written into the target bitstream as a sub-bitstream. The second bitstream may be written into the target bitstream when there are historical media frames.

Illustratively, the first bitstream is written into the encoded data portion of the target bitstream, and the second bitstream is written into the padding data portion or the in-band FEC data portion. The position where the second bitstream is written is not limited here, for example, a history multiple description bitstream of a previous media frame of the current media frame may be written into the in-band FEC data portion, or written into the padding data portion. Historical multiple description bitstreams of the historical media frames except the previous media frame, of the current media frame, are written into the padding data portion.

At least two current multiple description bitstreams of the current media frame can be written into at least two different target bitstreams respectively, the different target bitstreams correspond to different media frames, for example, one current multiple description bitstream is written into the target bitstream corresponding to the current media frame, and the other current multiple description bitstreams are written into media frames following the current media frame respectively. One multiple description bitstream of the current media frame can be written into the in-band FEC data portion of the next media frame, and can also be written into the padding data portion of the next media frame.

The bitstream format of the target bitstream can adopt the bitstream format of the set encoder, a first bitstream is encoded in the encoded data portion, and a second bitstream is encoded in the padding data portion. The target bitstream may include a frame header byte, a padding data total length byte, data content (i.e., encoded data portion), and a padding data portion.

The padding data portion of the target bitstream in the present disclosure comprises one or more bitstreams, historical media frame bitstreams, and/or enhanced coding information of the current media frame. In some embodiments, the target bitstream includes control information which indicates the number of all bitstreams included in the target bitstream. The target bitstream comprises control information which indicates the number of the bitstreams included in the target bitstream, capable of assisting a decoding end in decoding the target bitstream obtained based on the encoding of the multiple description bitstreams.

In some embodiments, the target bitstream further includes: in-band forward error correction data, which comprises one of at least two bitstreams of a previous historical media frame of the current media frame.

The bitstream of the historical media frame included in the padding data portion in the disclosure can be any bitstream of the historical media frame, can also be a bitstream of the historical media frame except the first bitstream of the historical media frame, and can also be a bitstream of the historical media frame, except the first bitstream of the historical media frame and a bitstream written into the compatible in-band FEC data portion. The enhanced coding information may be information obtained by processing the current media frame by using a set coding technique. The enhanced coding information can further enhance the audio quality and the packet loss resistance when decoding. The coding technique is not limited here.

In some embodiments, the enhanced coding information comprises at least one of bandwidth extension coding information, or redundant coding information. For example, the redundant coding information includes: in-band forward error correction coding information, which comprises one of at least two bitstreams of a certain historical media frame of the current media frame.

In some embodiments, the padding data further comprises: control information indicating whether the target bitstream carries enhanced coding information.

According to the technical solution of the embodiment of the disclosure, a current media frame is encoded into at least two bitstreams, and then a target bitstream is generated. The target bitstream comprises a data padding portion, the bitstream format of the target bitstream is a set bitstream format, and the set bitstream format can be the same as that of a set encoder, for example, the bitstream format of an Opus encoder, and all the generated target bitstreams can be decoded by a set decoder corresponding to the set encoder. The target bitstream can be directly transmitted to a receiving end, without additional calculation complexity and end-to-end delay caused by transcoding, and without additional degradation of communication quality caused by fallback, realizing the compatibility between a new encoder that executes the encoding method of the present disclosure and the set encoder. By including, in a padding data portion of the target bitstream, one or more current multiple description bitstreams, multiple description bitstreams of historical media frames, and/or enhanced coding information of the current media frame, the decoding quality and packet loss resistance are improved. Specifically, the target bitstream obtained by the encoding comprises a current multiple description bitstream of the current media frame, the data padding portion comprises the current multiple description bitstream, historical multiple description bitstreams of historical media frames and/or enhanced coding information of the current media frame, the multiple description bitstreams of one media frame can be distributed in different bitstreams, so that the media frame can be decoded by decoding any one bitstream, improving the packet loss resistance of the encoder.

In one embodiment, the encoding method further comprises: determining a second bitstream when there is a historical media frame before the current media frame.

The second bitstream is one of at least two bitstreams corresponding to the historical media frame. The frame number of the historical media frame is at least one, and the target bitstream also comprises the second bitstream.

The second bitstream may include at least one historical media frame, and each historical media frame corresponds to one of the at least two bitstreams. The number of the bitstreams corresponding to the historical media frames may be n.

The historical media frame may be considered as a media frame encoded prior to the current media frame. The historical media frame may be a previous frame of the current media frame, or previous M frames. The bitstream of the historical media frame (also referred to as the historical bitstream) may be considered as a technical term corresponding to the bitstream of the current media frame (also referred to as the current bitstream). The historical multiple description bitstream is a bitstream obtained by adopting the Multiple Description Coding technique for the historical media frames. The current multiple description bitstream is a bitstream obtained by adopting the Multiple Description Coding technique for the current media frame.

In this step, any unselected historical bitstream can be selected from the at least two historical bitstreams.

The second bitstream may include a bitstream selected corresponding to at least one historical media frame. For example, the second bitstream comprises a bitstream corresponding to each of previous M historical media frames of the current media frame, where M is a positive integer greater than or equal to 1.

In some embodiments, the bitstreams of the historical media frames include a kth bitstream of an ith historical media frame, where i is a positive integer less than or equal to M, k is a positive integer less than or equal to n, and n is the number of bitstreams and is a positive integer greater than or equal to 2.

Optionally, the first bitstream is a jth bitstream of the current media frame, where j is a positive integer less than or equal to n, and j≠k. Taking M=2 and n=2 as an example, if the first bitstream is the 1st bitstream of the current media frame, the bitstream of the historical media frame includes the 2nd bitstream of the ith historical media frame; and if the first bitstream is the 2nd bitstream of the current media frame, the bitstream of the historical media frame includes the 1st bitstream of the ith historical media frame. When the target bitstream of the current media frame is generated, one bitstream of the current media frame is written into the target bitstream, and when there is a historical media frame, one bitstream of the historical media frame is written into the target bitstream, improving the packet loss resistance of the generated target bitstream.

When at least two bitstreams obtained by the encoding are bitstreams with the multiple description technical characteristic, such as multiple description bitstreams, the target bitstream of the current media frame comprises different description bitstreams of the current media frame and historical media frames, and the current media frame with better quality can be obtained when the target bitstream is decoded.

In one embodiment, M=n−1, that is, the number of the second bitstream and the historical media frames is n−1, one historical media frame in the target bitstream corresponds to one second bitstream, and at least two bitstreams corresponding to one historical media frame are located in output bitstreams corresponding to different media frames.

Optionally, the bitstreams of the historical media frames further comprise a lth bitstream of the mth historical media frame, where m≠i, l≠j≠k, m is a positive integer less than or equal to M, and l is a positive integer less than or equal to n. Taking M=2 and n=3 as an example, if the first bitstream is the 1st bitstream of the current media frame, the bitstreams of the historical media frames may include the 2nd bitstream of the 1st historical media frame and the 3rd bitstream of the 2nd historical media frame, and may also include the 3rd bitstream of the 1st historical media frame and the 2nd bitstream of the 2nd historical media frame.

For the multiple description bitstream, the more different descriptions received by the decoder, the higher the quality of the current media frame decoded based on these different descriptions. Therefore, in the case of a plurality of historical media frames, the target bitstream of the current media frame includes different description bitstreams of the plurality of historical media frames, so that the current media frame with better quality can be obtained when the target bitstream is decoded.

In some embodiments, i=k. Taking M=3 and n=4 as an example, the bitstreams of the historical media frames may include the 1st bitstream of the 1st historical media frame, the 2nd bitstream of the 2nd historical media frame, and the 3rd bitstream of the 3rd historical media frame, where the first bitstream is the 4th bitstream of the current media frame.

The padding data portion of the target bitstream may include the second bitstream.

In one embodiment, the determining a second bitstream when there is a historical media frame before the current media frame, comprises: when there are historical media frames before the current media frame, for each of previous M historical media frames of the current media frame, selecting a bitstream from at least two bitstreams of the historical media frame, wherein the bitstream selected each time for the historical media frame is different; and determining the selected historical bitstream as the second bitstream.

In this embodiment, the second bitstream includes one bitstream corresponding to each frame (i.e. each historical media frame) of the previous M media frames (i.e. the previous M historical media frames) of the current media frame.

Each time when a historical bitstream is selected from a historical media frame, the selection can be made from unselected historical bitstreams, and the unselected historical bitstreams can be regarded as historical bitstreams not selected as the second bitstream, for example, historical bitstreams not selected by other media frames as the second bitstream during encoding.

In this embodiment, a number may be selected from numbers of the unselected historical bitstreams, and the historical bitstream corresponding to the number is taken out from the media frame. Each historical bitstream can have a unique number for distinguishing different historical bitstreams. The numbering mode is not limited, and can be determined based on the sequence of encoding and generating the historical bitstreams, and also can be determined based on the sequence of storing the bitstreams in a cache pool.

In one embodiment, for each of previous M historical media frames of the current media frame, selecting a bitstream from at least two bitstreams of the historical media frame, comprises: for each of the previous M historical media frames of the current media frame, obtaining unselected bitstreams of the historical media frame from a cache pool; and selecting one bitstream from the unselected bitstreams.

The cache pool can be regarded as a cache region for caching bitstreams. The bitstreams cached by the cache pool may include current bitstreams unselected as the first bitstream, of the current media frame, and unselected bitstreams of the historical media frame.

The caching mode of the bitstreams in the cache pool is not limited. The bitstreams can be classified and stored according to the number of frames in which the bitstreams are cached. The number of frames required for caching each bitstream may be preset, but it is not limited here, for example, it may be based on the corresponding quantization mode, or coded sequence, or ordered sequence (the ordering is not limited).

In an embodiment, each of the historical bitstreams is sequentially read according to a set sequence, the cache pool sets different cache regions according to different frame numbers required for caching the bitstreams, the cached bitstreams include the bitstreams cached by the current media frame and the historical media frames, the bitstreams cached by the current media frame include the bitstreams in the at least two bitstreams except the first bitstream, and the caching mode of the cached bitstreams of the historical media frames is the same as the caching mode of the cached bitstreams of the current media frame.

The set sequence is not defined, and may be determined based on the number of frames required for the caching and/or the sequence in which the bitstreams are written into the cache pool. The plurality of bitstreams may be read in a first-in-first-out manner.

The cache pool may include a plurality of cache regions, where the number of frames required for caching the bitstreams in different cache regions is different, and the bitstreams cached in each cache region may follow a first-in first-out principle. The bitstreams cached by the current media frame comprise the bitstreams except the first bitstream in the n bitstreams.

The cached bitstreams of the current media frame include the bitstreams in the at least two bitstreams except the first bitstream, and when the current media frame is subsequently taken as the historical media frame from which the bitstreams are selected, the cached bitstreams of the current media frame may include unselected bitstreams of the current media frame.

The bitstreams cached in the cache pool may include unselected bitstreams of the historical media frame.

In one embodiment, the generating a target bitstream of the current media frame, comprises: encoding the first bitstream to a encoded data portion of the target bitstream; encoding the second bitstream and control information to a padding data portion of the target bitstream, wherein the control information includes the number of multiple description bitstreams included in the target bitstream, and the multiple description bitstreams included in the target bitstream include the first bitstream and the second bitstream.

The encoded data portion may be considered as a portion where encoded data is stored. The padding data portion may be considered as a portion where padding data is stored. The control information may be regarded as indication information indicating data packed by the target bitstream. For example, the control information includes the number of the multiple description bitstreams included in the target bitstream.

In one embodiment, the control information may indicate the number of the second bitstream carried by the target bitstream.

In one embodiment, the control information may indicate indication information of data carried by the padding data portion. For example, the control information may indicate whether the padding data portion carries bandwidth extension data, whether in-band FEC data is carried, and an offset of the carried in-band FEC data.

In the embodiment, when the second bitstream and the control information are encoded to the data padding portion, the control information may be encoded first, and then the second bitstream may be encoded.

The number of the multiple description bitstreams may indicate the number of the first bitstream and the second bitstream included in the target bitstream, wherein the number of the first bitstream may be one, and the number of the second bitstream may be one or more.

In one embodiment, the generating a target bitstream of the current media frame, comprises: when there is a previous media frame before the current media frame, obtaining at least two bitstreams of the previous media frame; selecting a bitstream from bitstreams of the previous media frame, wherein the selected bitstream is one of n−1 bitstreams except the first bitstream of the previous media frame; and encoding the selected bitstream to a forward error correction position of the target bitstream of the current media frame.

The embodiment can obtain n bitstreams of the previous media frame.

The previous media frame may be considered as a media frame encoded prior to the current media frame. In the embodiment, when the target bitstream is generated, in addition to encoding the first bitstream and the second bitstream to the target bitstream, one bitstream of the previous media frame may be encoded to a forward error correction position, so as to improve packet loss resistance.

The historical bitstream encoded to the forward error correction position of the target bitstream may be any one of the bitstreams of the previous media frame except the first bitstream of the previous media frame.

The forward error correction position of the target bitstream may be located at a compatible portion of the target bitstream, and the forward error correction position of the target bitstream is a forward error correction position compatible with bitstreams of the set encoder, such as a forward error correction position compatible with bitstreams of the Opus encoder.

The forward error correction position of the set encoder may be a forward error correction position of the target bitstream, for example, the position of the in-band FEC data in FIG. 1b may be taken as a forward error correction position of the target bitstream for padding the history bitstream selected from the previous media frame in this embodiment. Portions of the target bitstream except the padding data portion can be compatible with the bitstream of the set encoder, such as the same bitstream format.

When the history bitstream of the previous media frame is encoded to the forward error correction position, the rest of the history bitstreams of the previous media frame and the history bitstreams encoded to the forward error correction position, may not be encoded to the padding data portion of the target bitstream.

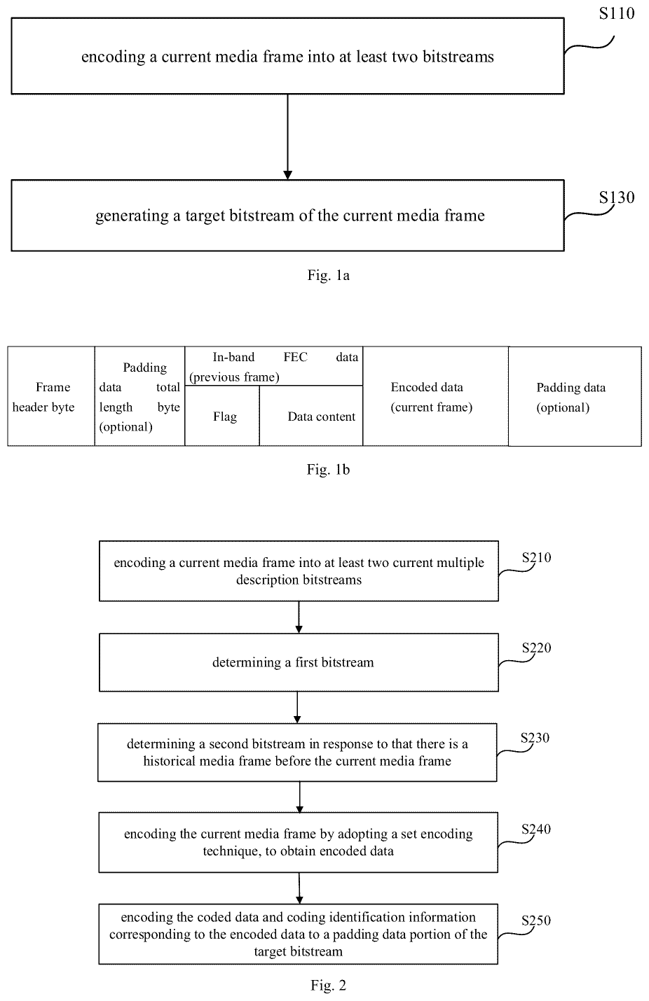

FIG. 2 is a schematic flowchart of another encoding method provided in an embodiment of the present disclosure, and the multiple description bitstream is taken as an example for description below.

The embodiment also comprises the step of encoding the current media frame by adopting a set coding technique, to obtain encoded data; correspondingly, the generating a target bitstream of the current media frame, comprises: encoding the encoded data and coding identification information corresponding to the encoded data to a padding data portion of the target bitstream, wherein the coding identification information indicates whether the encoded data is carried in the target bitstream, and the enhanced coding information comprises the encoded data and the coding identification information.

Referring to FIG. 2, the method comprises:
S210, encoding a current media frame into at least two current multiple description bitstreams;
S220, determining a first bitstream;
S230, when there is a historical media frame before the current media frame, determining a second bitstream; and
S240, encoding the current media frame by adopting a set coding technique, to obtain encoded data.

The set coding technique is not limited, and may be set according to the encoder requirements, for example, a technique that may include at least one enhanced encoder, and the encoded data obtained by the set coding technique may enhance the quality and/or the packet loss resistance of the decoded multimedia.

The set coding technique includes, but is not limited to, an in-band FEC coding technique and/or a bandwidth extension coding technique.

Different set coding techniques can be used for encoding to obtain different encoded data. No limitation is made on how to encode here.

The method further comprises S250, encoding the encoded data and coding identification information corresponding to the encoded data to a padding data portion of the target bitstream.

The enhanced coding information includes the encoded data and the coding identification information. The coding identification information indicates whether the target bitstream carries the encoded data. The encoded data and the coding identification information have a one-to-one correspondence, for indicating whether the corresponding encoded data is encoded to the target bitstream.

After the encoded data is obtained, the encoded data and the coding identification information corresponding to the encoded data may be encoded to the padding data portion in this step, so that the decoding end may decode the encoded data from the padding data portion, to assist decoding.

The encoded data portion of the encoded target bitstream comprises the first bitstream, when there is a historical media frame before the current media frame, the target bitstream comprises the second bitstream, and the padding data portion of the target bitstream comprises the encoded data and the corresponding coding identification information.

According to the embodiment of the disclosure, when the current media frame is encoded, the set coding technique is adopted for coding to obtain the encoded data, and the encoded data and the corresponding coding identification information are encoded to the target bitstream, so that the decoding end can assist in decoding based on the encoded data, improving the decoding quality.

In one embodiment, the set coding technique includes an in-band Forward Error Correction (FEC) technique, the in-band FEC technique corresponds to an offset k, which indicates what is corresponded is redundant coding information of a previous kth frame of the current media frame, the control information included in the padding data portion includes the coding identification information and the offset, the control information included in the padding data portion is encoded in a control byte of the padding data portion, and the included encoded data is encoded after the control byte.

In this embodiment, an in-band FEC technique may be used to encode the current media frame to obtain the encoded data. What is encoded by using the in-band FEC technique may be a previous kth media frame of the current media frame, where k may be greater than n−1. The offset characterizes the media frame encoded based on the in-band FEC technique. It can be determined from the offset, redundant coding information of which media frame is encoded by the padding data portion of the target bitstream. The decoding of the target bitstream of the previous kth frame of the current media frame can be assisted based on the redundant coding information.

The control byte can be regarded as a byte for controlling decoding, in the padding data portion of the target bitstream. The control byte may be followed in turn by the second bitstream and the encoded data. The control byte may include the coding identification information.

According to an embodiment of the present disclosure, there is also provided a decoding method, comprising: obtaining a target bitstream of a current media frame, wherein the target bitstream comprises encoded data and padding data, the encoded data comprises a first bitstream, the first bitstream is one of at least two bitstreams of the current media frame, and the padding data comprises at least one of bitstream(s) other than the first bitstream, bitstreams of historical media frames, or enhanced coding information of the current media frame; and decoding the target bitstream, to obtain the current media frame.

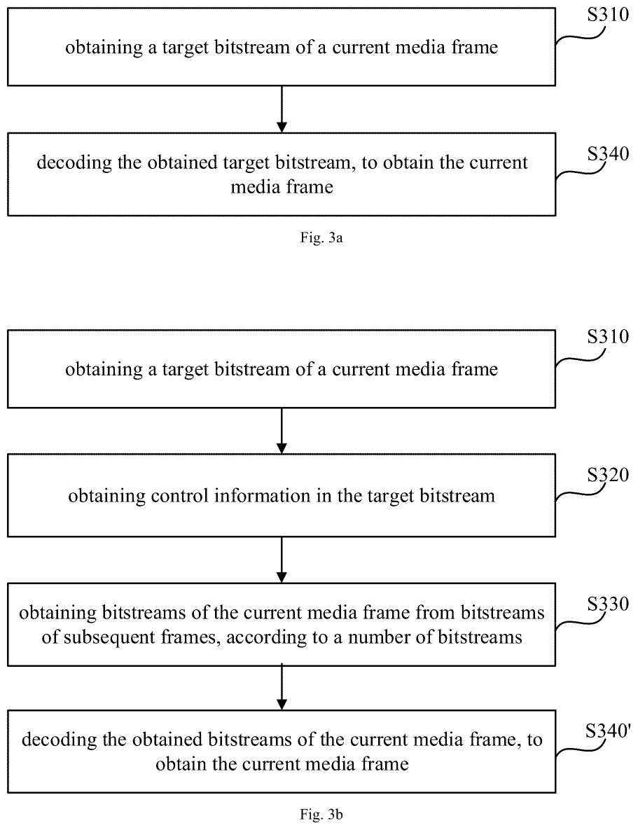

FIG. 3a is a schematic flowchart of a decoding method provided in an embodiment of the present disclosure. Referring to FIG. 3a, the embodiment of the present disclosure is applicable to a situation of decoding a target bitstream, and the method may be executed by a decoding apparatus, and the apparatus may be implemented in the form of software and/or hardware, and optionally, implemented by an electronic device, and the electronic device may be a mobile terminal, a PC end, a server, or the like. The electronic device for executing the encoding method and the electronic device for executing the decoding method may be different electronic devices. Each electronic device may be integrated with an encoding method and a decoding method.

As shown in FIG. 3a, the decoding method comprises: S310, obtaining a target bitstream of a current media frame; and S340, decoding the target bitstream, to obtain the current media frame.

The target bitstream is, for example, a bitstream generated after encoding the current media frame. The target bitstream comprises encoded data and padding data. In some embodiments, the target bitstream further includes: in-band forward error correction data which comprises one of at least two bitstreams of a previous historical media frame of the current media frame. For example, the target bitstream is an Opus bitstream.

The encoded data comprises a first bitstream which is one of at least two bitstreams of the current media frame, and the padding data comprises at least one of bitstream(s) other than the first bitstream, bitstreams of historical media frames, or enhanced coding information of the current media frame.

In some embodiments, the at least two bitstreams are multiple description bitstreams. The padding data comprises one or more current multiple description bitstreams of the current media frame, historical multiple description bitstreams of historical media frames and/or enhanced coding information of the current media frame, and the first bitstream is one of at least two current multiple description bitstreams of the current media frame.

The bitstreams of the historical media frames may include one bitstream of at least two bitstreams of at least one historical media frame.

The bitstreams of the historical media frames may also include: one bitstream of at least two bitstreams of each of previous M historical media frames of the current media frame, where M is a positive integer greater than or equal to 1.

In some embodiments, the bitstream of the historical media frames includes a kth bitstream of an ith historical media frame, where i is a positive integer less than or equal to M, n is the number of bitstreams and is a positive integer greater than or equal to 2, and k is a positive integer less than or equal to n. For example, in the case that the at least two bitstreams are multiple description bitstreams, M=n−1.

Optionally, the first bitstream is a jth bitstream of the current media frame, where j is a positive integer less than or equal to n, and j≠k. Taking M=2 and n=2 as an example, if the first bitstream is the 1st bitstream of the current media frame, the bitstream of the historical media frame includes the 2nd bitstream of the ith historical media frame; and if the first bitstream is the 2nd bitstream of the current media frame, the bitstream of the historical media frame includes the 1st bitstream of the ith historical media frame.

Optionally, the bitstream of the historical media frame further includes a lth bitstream of the mth historical media frame, where m≠i, l≠j≠k, m is a positive integer less than or equal to M, and l is a positive integer less than or equal to n. Taking M=2 and n=3 as an example, if the first bitstream is the 1st bitstream of the current media frame, the bitstreams of the historical media frames may include the 2nd bitstream of the 1st historical media frame and the 3rd bitstream of the 2nd historical media frame, and may also include the 3rd bitstream of the 1st historical media frame and the 2nd bitstream of the 2nd historical media frame.

In some embodiments, i=k. Taking M=3 and n=4 as an example, the bitstreams of the historical media frames may include the 1st bitstream of the 1st historical media frame, the 2nd bitstream of the 2nd historical media frame, and the 3rd bitstream of the 3rd historical media frame, where the first bitstream is the 4th bitstream of the current media frame. In some embodiments, the padding data further comprises: control information indicating the number of bitstreams included in the target bitstream.

In other embodiments, the padding data further comprises: control information indicating whether the target bitstream carries enhanced coding information. The enhanced coding information may include at least one of bandwidth extension coding information and redundant coding information. For example, the redundant coding information includes: in-band FEC coding information which comprises one of at least two bitstreams of a certain historical media frame of the current media frame. After the target bitstream is obtained, in the step, the first bitstream may be obtained from the target bitstream, for example, the first bitstream is obtained from the encoded data portion of the target bitstream. In this step, when the first bitstream is obtained, the obtaining may be based on information carried by a frame header byte of the target bitstream. For example, it is determined whether the target bitstream carries padding data based on the frame header byte, and if so, a total length of the padding data portion can be analyzed from bytes after the frame header byte.

The first bitstream in the compatible portion of the target bitstream is obtained based on the length of the target bitstream and the total length of the data padding portion. For example, based on the length of the target bitstream and the total length of the data padding portion, the compatible portion is determined, and the first bitstream is extracted from the compatible portion. Since the bitstream format is fixed, the position of the first bitstream in the compatible portion is known.

FIG. 3b is a flowchart illustrating another decoding method provided in an embodiment of the disclosure. FIG. 3b differs from FIG. 3a in that steps S320 and S330 are further included.

The method comprises S320, obtaining control information in the target bitstream.

In the step, whether a padding data portion exists can be determined through the frame header byte, and if so, control information included in the padding data portion can be obtained, which indicates the number of all multiple description bitstreams included in the target bitstream. Whether a second bitstream exists in the padding data portion of the target bitstream can be determined based on the control information. If the number indicated by the control information is greater than a set number, such as 2 or 3, it can be considered that the second bitstream exists. The set number may be the number of bitstreams included in the compatible portion.

If the second bitstream exists, the second bitstream may be obtained from a position corresponding to the padding data portion, and a padding position of the second bitstream may be preset, or may be indicated by a control byte.

The second bitstream may be used for decoding the historical media frames.

The method comprises S330, obtaining bitstreams of the current media frame from bitstreams of subsequent frames, according to the number of bitstreams. The bitstreams of the current media frame may be multiple description bitstreams. The following description takes the multiple description bitstream as an example.

The target bitstream of S310 may be a bitstream of one frame, and this step may continue to obtain multiple description bitstreams of the current media frame from bitstreams of subsequent frames. The multiple description bitstream of the current media frame may be encoded in different bitstreams.

The number of the multiple description bitstreams indicated by the control information may decide how many frames are to be further obtained from the subsequent bitstreams. The frame number of the subsequent bitstreams may be the number of the multiple description bitstreams minus 1, or the number of the multiple description bitstreams minus 2.

When the compatible portion has the in-band FEC data, the frame number of the bitstreams of the subsequent frames, namely the subsequent bitstreams, is the number of the multiple description bitstreams minus 2, namely n−2. When the compatible portion does not have the in-band FEC data, the frame number of the subsequent bitstreams is the number of the multiple description bitstreams minus 1, namely n−1.

After the subsequent bitstreams are obtained, the multiple description bitstreams of the current media frame can be obtained from the subsequent bitstreams. The multiple description bitstreams of the current frame may be in padding data portions of the subsequent bitstreams, or in in-band FEC portions of the compatible portions of the subsequent bitstreams.

In one embodiment, the number of the multiple description bitstreams is n, the subsequent bitstreams are n−1 frames following the current media frame, and the number of the obtained multiple description bitstreams of the current media frame is 0 to n−1.

In one embodiment, if the compatible portion does not have in-band FEC data, when the number of the multiple description bitstreams is n, the subsequent bitstreams are n−1 frames following the current media frame, and the number of the obtained multiple description bitstreams of the current media frame is 0 to n−1.

S340′ is further described below with reference to FIG. 3b: decoding according to the obtained bitstreams (such as multiple description bitstreams) of the current media frame, to obtain the current media frame.

In one embodiment, the multiple description bitstreams corresponding to the current media frame may include a first bitstream in the target bitstream and a multiple description bitstream corresponding to the current media frame in a second bitstream of the subsequent bitstreams.

In an embodiment, the multiple description bitstream corresponding to the current media frame may include a first bitstream in the target bitstream, in-band FEC data included in a subsequent bitstream, and a current multiple description bitstream corresponding to the current media frame in a second bitstream in a target bitstream received after the subsequent bitstream.

In an embodiment, the multiple description bitstream corresponding to the current media frame may include a first bitstream included in the target bitstream and in-band FEC data included a subsequent bitstream. The subsequent bitstream may be a next bitstream after the target bitstream.

In this step, when the multiple description bitstream corresponding to the current media frame is decoded, all the bitstreams can be transmitted to a multiple description decoder, so as to obtain the current media frame. Or post-processing can be performed after inputting to the multiple description decoder to obtain the current media frame. The post-processing means is not limited.

The present embodiment provides a decoding method, by which a target bitstream can be decoded, and the target bitstream can be obtained by encoding with the encoding method provided in the embodiment of the present disclosure. When the target bitstream is decoded, candidate bitstreams are obtained based on the indication of the control information, so that a plurality of current multiple description bitstreams can be obtained, improving the decoding quality.

In one embodiment, an end condition includes: the number of attempts to obtain the target bitstream is n.

In this embodiment, at least two current multiple description bitstreams of the current media frame may be encoded into at least two target bitstreams. Therefore, the decoding may be made after n times of attempts to obtain the target bitstream, and in the n times of attempts to obtain the target bitstream, the target bitstream can be obtained or not in each attempt, then the multiple description bitstreams of the at least two target bitstreams can be obtained.

In one embodiment, the decoding method provided by the present disclosure further comprises: if a current multiple description bitstream of the current media frame is not obtained, obtaining redundant coding information of the current media frame from a bitstream carrying the redundant coding information of the current media frame; and decoding the redundant coding information.

The bitstream carrying the redundancy coding information of the current media frame can carry the redundancy coding information of the current media frame in the form of FEC data in the data padding portion. The FEC data may be regarded as encoded data encoded by using an in-band Forward Error Correction technique, namely an FEC technique. The FEC data may be redundant coding information of the current media frame.

In one embodiment, the redundant coding information is carried in a padding data portion of the corresponding target bitstream.

In an embodiment, the bitstream carrying the redundant coding information of the current media frame is a target bitstream of a kth frame after the target bitstream of the current media frame.

An offset between the bitstream carrying the redundant coding information of the current media frame and the target bitstream is equal to an offset k carried by the control information of the target bitstream. k is greater than n−1.

In one embodiment, the obtaining redundant coding information of the current media frame from a bitstream carrying the redundant coding information of the current media frame, comprises: obtaining an offset corresponding to the redundant coding information in a control byte of the target bitstream; obtaining a bitstream carrying the redundant coding information of the current media frame, wherein the bitstream is a bitstream offset by the offset after the target bitstream; and obtaining the redundant coding information of the current media frame in the bitstream.

The present embodiment may obtain a control byte from starting data of the padding data portion. The control byte carries the offset corresponding to the redundant coding information, and the offset indicates an offset between the bitstream carrying the redundant coding information and the target bitstream.

The present embodiment obtains the bitstream indicated by the offset, and then obtains the redundant coding information from the padding data portion of the bitstream.

The present disclosure can also obtain coding identification information carried by the control byte, which can indicate whether the redundant coding information exists in the padding portion of the target bitstream. If so, the redundant coding information may be obtained from the padding data portion.

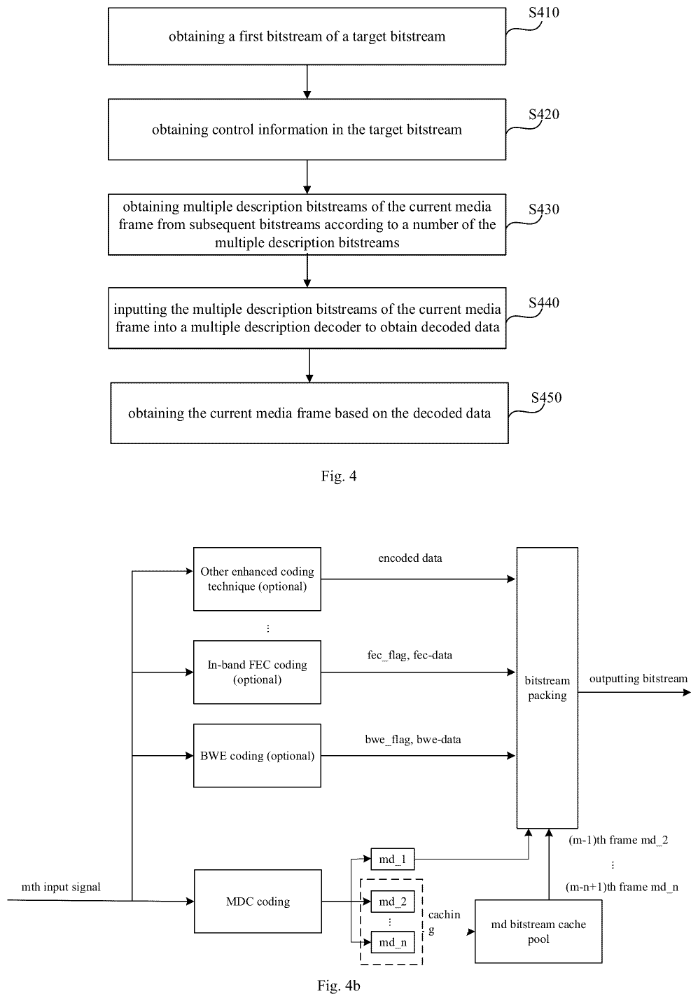

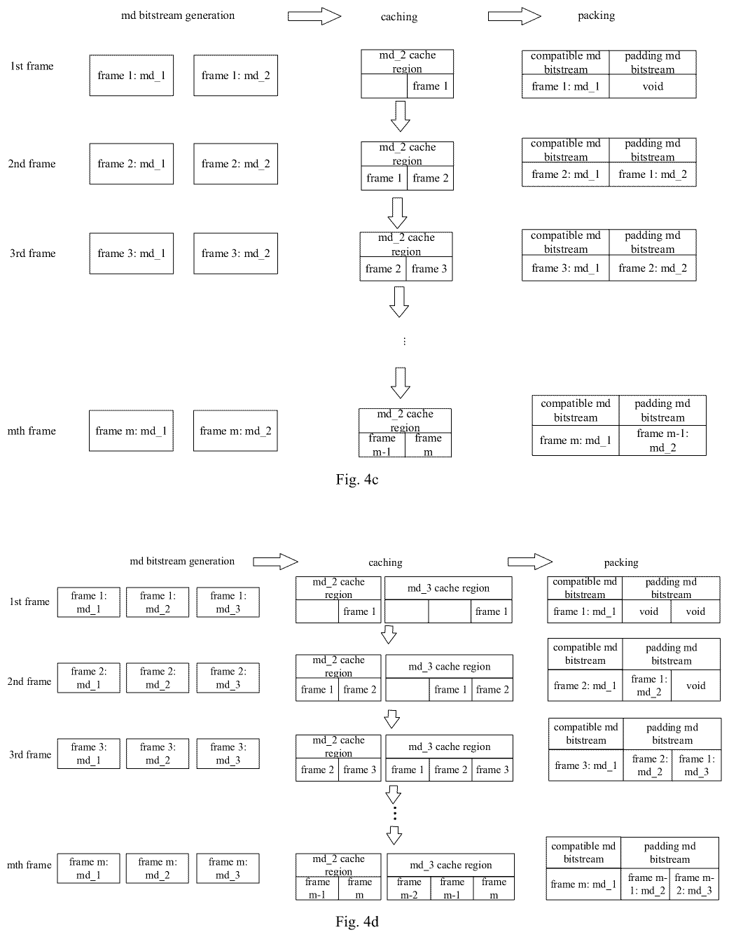

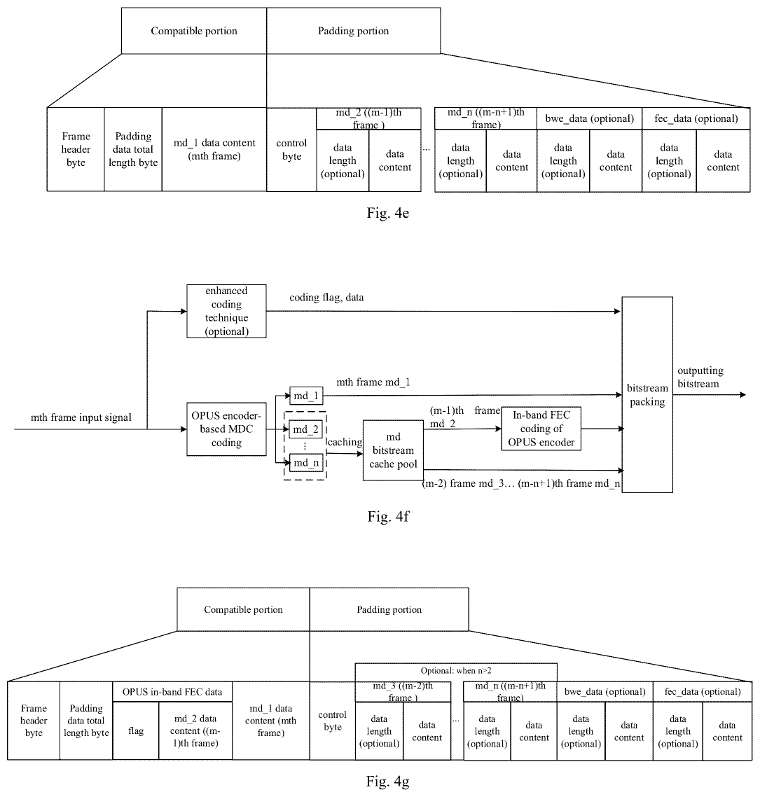

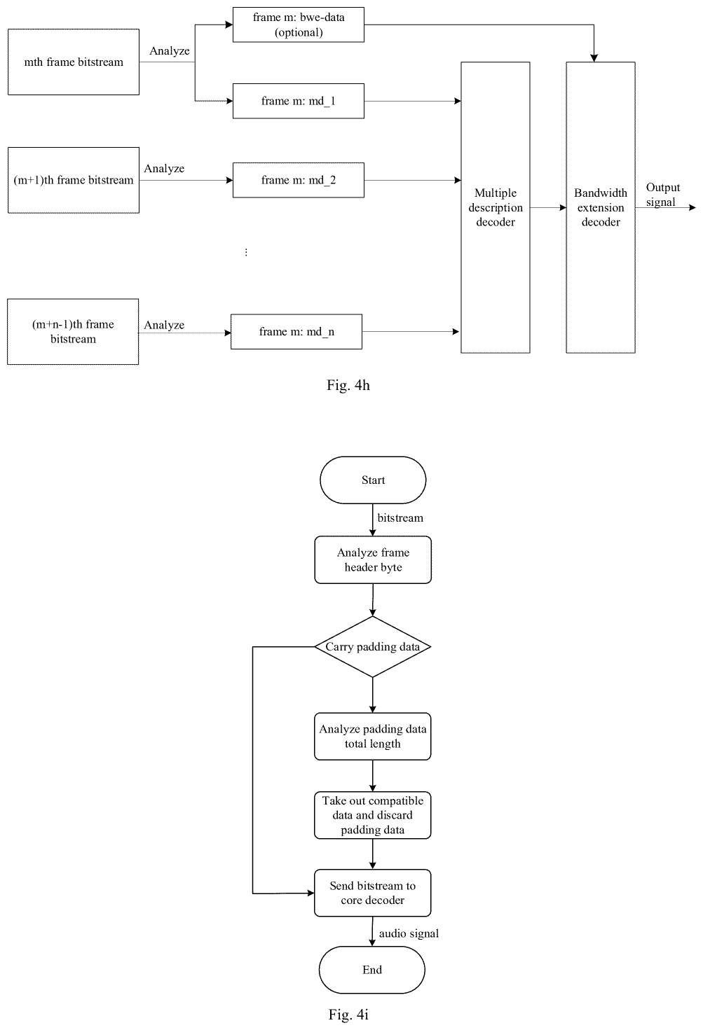

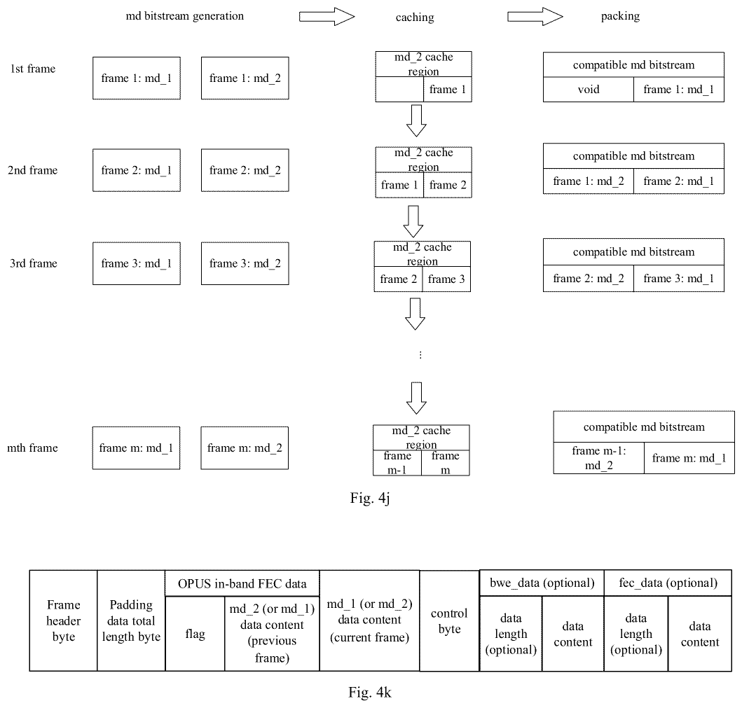

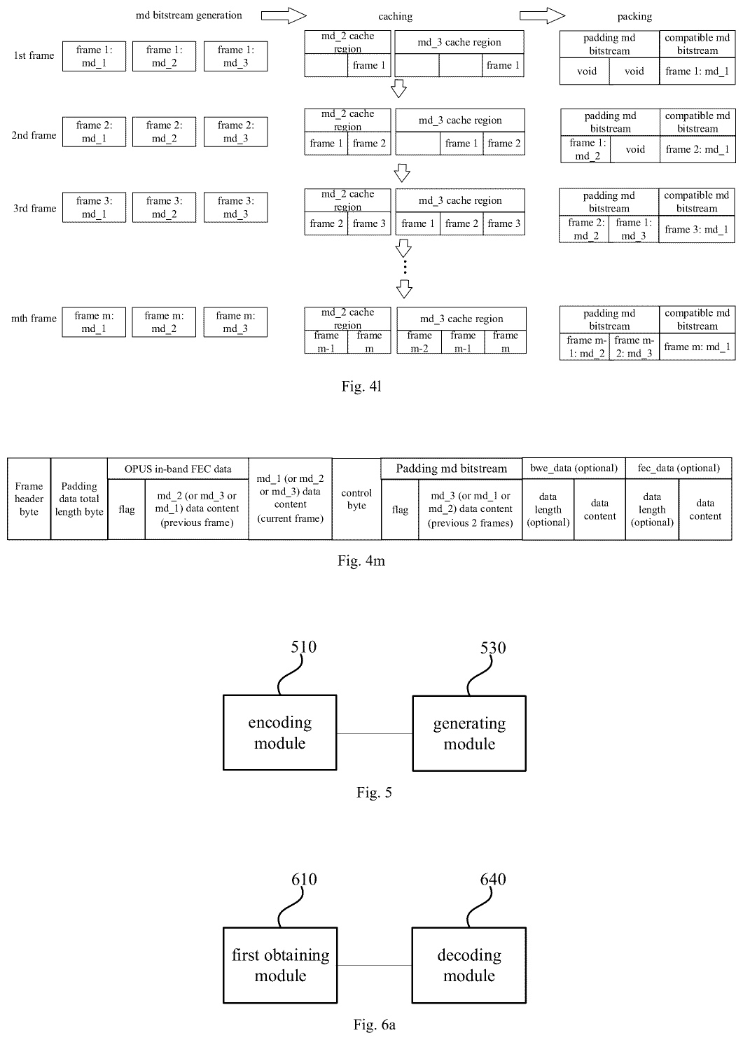

In one embodiment, a target bitstream of the mth frame is obtained, and redundant coding information of a padding data portion of the target bitstream is redundant coding information of m-k frames. FIG. 4a is a schematic flowchart of another decoding method provided in an embodiment of the present disclosure, where, on the basis of the foregoing embodiment, decoding is made according to the obtained multiple description bitstream of the current media frame to obtain the current media frame, which comprises: inputting the multiple description bitstream of the current media frame into a multiple description decoder to obtain decoded data; and obtaining the current media frame based on the decoded data.

The method comprises: S410, obtaining a first bitstream of a target bitstream; S420, obtaining control information in the target bitstream; S430, according to the number of the multiple description bitstreams, obtaining multiple description bitstreams of the current media frame from subsequent bitstreams; and S440, inputting the multiple description bitstreams of the current media frame into a multiple description decoder to obtain decoded data.

The multiple description decoder can decode the multiple description bitstream, and the decoding mode is not limited as long as it corresponds to the encoding end. When the encoder encodes the multiple description bitstream, the same encoding method as that of the set encoder, such as a quantization mode, may be used, and when the quantization mode is used to determine a quantized signal, a set formula may be used to determine a quantization formula, and the multiple description decoder in this step may also use the set formula to determine the decoded data.

For example, the encoding side determines a quantization error between the multiple description bitstream and the current media frame by using a set formula, so as to finally determine the multiple description bitstream; in this step, a decoder corresponding to the multiple description encoder may process the multiple description bitstream by using the set formula to obtain the decoded data, or process it by using the set formula after updating the multiple description bitstream to obtain decoded data, and the updating means is not limited and may be the same as that of the set encoder. The multiple description bitstream may be taken as an independent variable of the set formula, and a dependent variable of the set formula may be the decoded data.

The method comprises S450, obtaining the current media frame based on the decoded data.

After the decoded data is obtained, the decoded data can be directly determined as the current media frame, or the decoded data can also be further processed to obtain the current media frame. The further processing means is not limited, and the encoded data may be further processed based on the encoded data in the target bitstream.

In one embodiment, the obtaining the current media frame based on the decoded data, comprises: obtaining bandwidth expansion data carried by a padding data portion of the target bitstream; and processing the decoded data based on the bandwidth extension data to obtain the current media frame.

The bandwidth extension data may be considered as data encoded based on a bandwidth extension technique.

The obtaining mode is not limited, and in-band extension data may be obtained from a corresponding position based on an indication of a control byte in the object bitstream. The control byte may indicate whether bandwidth extension data is included, and the location of the bandwidth extension data may be a default location or may be indicated by the control byte.

After the bandwidth extension data is obtained, the bandwidth extension data and the decoded bitstream of the current media frame may be input to a bandwidth extension decoder, to obtain a final decoded signal, that is, the current media frame.

On the basis of the decoding, the bandwidth extension data is also decoded, further improving the quality of the output signal of the decoder.

The embodiment of the disclosure discloses a decoding method, which performs decoding through a multiple description decoder, to obtain the current media frame corresponding to the multiple description bitstream, improving the decoding quality.

In an embodiment, the obtaining control information in the target bitstream, comprises: analyzing a bitstream length and a padding portion length of the target bitstream; determining an initial position of the padding portion of the target bitstream based on the bitstream length and the padding portion length; and analyzing the padding portion based on the initial position to obtain the control information.

The bitstream length is obtained from a frame header byte of the target bitstream, and the padding portion length is obtained from a padding data total length byte after the frame header byte. The initial position of the padding portion of the target bitstream may be determined based on a difference between the bitstream length and the padding portion length.

Control information of the padding portion is obtained from the initial position. The control information may be located at the initial position of the padding portion, occupying set bytes.

The present disclosure is exemplarily described below, and the encoding and decoding method provided by the present disclosure may be considered as a method for generating an audio signal compatible bit bitstream, that is, a single bitstream encoding method compatible with a bitstream format, and may also be understood as an audio encoding and decoding method compatible with a single bitstream format.

Related codecs cannot meet the high quality requirements of users, which requires service providers to upgrade the audio codecs to improve the quality of the encoded audio.

However, not all users will upgrade to a new version of encoder, and there will always be a situation where new and old versions coexist, and in order to enable an old terminal to still use an old version of codec for communication, it is necessary to ensure compatibility between the new and old versions of codec.

The related method for processing the compatibility problem of the old and new encoders comprises transcoding and fallback, wherein transcoding has problems of increasing the computational complexity and end-to-end delay, and fallback has a problem of degrading the communication quality. Therefore, how to ensure the compatibility between the new encoder and the old decoder without causing additional end-to-end delay and degradation of communication quality is a technical problem to be solved.

In this disclosure, to introduce the multiple description coding technique on the basis of the Opus encoder, the following technical problems shall be solved:
1. on the premise that no additional overhead is caused and user experience is not affected, ensuring the compatibility between a new encoder and an old encoder, namely a set encoder; and
2. when the bitstream generated by the multiple description coding is transmitted using multiple data links, causing more RTP header overhead.

In view of the above technical problems, the encoding method provided by the present disclosure has the following beneficial effects:

1. The new encoder (the encoder that executes the encoding method of the present discloses) uses a compatible encoding mode, the generated bitstream (namely the target bitstream) is completely compatible with the old encoder (such as a set encoder), without making transcoding or fallback, the decoder of the old terminal can directly decode the enhanced new version bitstream (namely the target bitstream), and the decoded audio quality is basically consistent with the quality of the encoded data of the old terminal, without affecting the communication experience of new and old users after the encoder is upgraded, and without additional calculation complexity and end-to-end delay.

2. The new audio encoder realizes multiple description coding on the basis of transmitting a single bitstream, without additional RTP header expansion overhead. By caching and analyzing the received bitstream correspondingly at the decoding end, one or more description bitstreams in the same audio band are decoded, improving the packet loss resistance of the codec.

3. The new audio encoder introduces enhanced encoder technologies such as Bandwidth Extension (BWE) and in-band FEC, in addition to the multiple description coding method, on the basis of the old encoder, the generated related encoded data is placed in a padding portion of an output bitstream, namely a padding data portion (note: other enhanced encoder technologies can also be introduced, and the generated related data is also placed in the padding portion of the bitstream, to ensure the compatibility with the old encoder), and the new decoder can further enhance the audio quality and the packet loss resistance by using the two portions of data when decoding.

Note: the new encoding method of the present disclosure (i.e., the encoding method) is also applicable to other encoders having padding data fields, in addition to implementing the multiple description coding in a condition compatible with the Opus encoder.

FIG. 4b is a schematic encoding flowchart of an encoding method provided in an embodiment of the present disclosure. Referring to FIG. 4b, the encoding flow is as follows:

1. The new encoder generates at least two bitstreams, namely at least two current multiple description bitstreams (n>=2), by using the MDC coding method, wherein each bitstream is compatible with an old audio encoder and is respectively represented by md_1, md_2, . . . , md_n;

2. The new encoder respectively generates a corresponding coding flag (i.e. coding identification information) and encoded data by using the BWE technology and the in-band FEC technology, where the coding flag is represented by bwe_flag, fec_flag, which means whether the bitstream (target bitstream) carries BWE encoded data (coded data obtained by using the BWE technology), in-band FEC encoded data (coded data obtained by using the FEC technology), and the encoded data is represented by bwe_data, fec_data, wherein the in-band FEC may freely configure an offset k to represent that redundant encoding information of a previous kth frame of the current frame is carried; besides these two technologies, other technologies that may enhance the encoder may be added, and a packing mode of the generated encoded data is the same as that of the BWE and in-band FEC.

3. The md bitstream generated by the new encoder, and the bwe bitstream (namely BWE encoded data) and fec bitstream (namely FEC encoded data) etc. used for enhancing the encoder, are packed into a coded bitstream; for the md bitstream, one of all md bitstreams generated by the current frame is selected and placed in a portion (such as md_1) compatible with the bitstream of the old encoder, the rest n−1 md bitstreams are placed into a cache pool for cache processing, to respectively cache 1, 2, . . . , n−1 frames, then the bitstreams with the corresponding md number in the previous 1, 2, . . . , n−1 frames are respectively taken out of the cache pool, and the taken out md bitstreams are spliced together with the bwe bitstream and the fec bitstream and placed in a padding portion of an output bitstream.

FIG. 4c is a schematic diagram of a bitstream entering and exiting a cache region, provided in an embodiment of the present disclosure, where a process that a md bitstream is put into a cache region and taken out of the cache region for packing is shown in FIG. 4c; assuming that n takes a value of 2, it can be seen that md_2 caches a frame, a cache pool only includes a cache region of md_2, and when a current media frame of the 1st frame is encoded, current multiple description bitstreams md_1 and md_2 are obtained. md_1 is encoded into a target bitstream, and md_2 is put into the cache region. Because the current media frame is the first frame, the second bitstream does not exist in the target bitstream.

When the 2nd frame media frame is encoded, the md_1 of the 2nd frame is written into the corresponding target bitstream, and the md_2 is put into the cache region. The target bitstream corresponding to the 2nd media frame includes the second bitstream, i.e. md_2 of the 1st frame. And so on.

FIG. 4d is a schematic diagram of another bitstream entering and exiting a cache region, provided in an embodiment of the present disclosure, where a process that an md bitstream is put into a cache region and taken out of the cache region for packing is shown in FIG. 4d, wherein md_2 caches one frame, and md_3 caches two frames. Then, 2 md bitstreams are put in the padding portion, so that the 2 md bitstreams of each media frame are cached.

Referring to FIG. 4d, when the 1st media frame is encoded, md_1 is put into the corresponding target bitstream, and the rest mds are cached. Since no historical media frame exists, no second bitstream exists in the target bitstream. When the 2nd media frame is encoded, md_1 is put into the corresponding target bitstream, md_2 of the 1st frame is written into the target bitstream of the 2nd frame as the second bitstream; when the 3rd media frame is encoded, md_1 is put into the corresponding target bitstream, md_2 of the 2nd frame and md_3 of the 1st frame are written into the target bitstream of the 3rd frame as the second bitstream, and so on.

FIG. 4e is a schematic diagram of a bitstream format provided in an embodiment of the present disclosure, and referring to FIG. 4e, the target bitstream includes a compatible portion and a padding portion, namely a padding data portion.

The 1st to 2nd bytes of the compatible portion are frame header bytes which carry attributes (frame length, coding bandwidth, channel number and the like) of the audio frame, a flag bit indicating variable rate coding or not, and a flag bit indicating whether the bitstream carries padding data; if the padding data is carried, a byte indicating the padding portion total length will be inserted after the frame header byte. The number of bytes described in this disclosure is exemplary and not limiting.

The first byte of the padding portion is a control byte which carries information such as the number of md bitstreams (i.e., the number of multiple description bitstreams included in the target bitstream), a flag bit indicating bandwidth extension data or not (that is, coding identification information corresponding to coding by adopting BWE technology), a flag bit indicating in-band FEC data or not (that is, coding identification information corresponding to coding by adopting FEC technology) and an offset of the in-band FEC data, and the control byte is followed by the padded md bitstreams, bwe bitstreams and fec bitstreams; in the case of variable rate coding, a byte indicating a data length is inserted preceding the data of each bitstream. That is, the data length preceding the data content can indicate a length of the corresponding data content.

In FIG. 4e, taking the bitstream of the mth frame as an example, assume that the compatible portion stores md_1 data of the mth frame, and the padding portion stores md_2 data of the (m−1)th frame, md_3 data of the (m−2)th frame, . . . , md_n data of the (m-n+1)th frame.

The above-described coding scheme can be used for an encoder having a data padding field in any one of the bitstreams.

The following describes an encoding generation method for the Opus encoder:

The bitstream structure of the Opus encoder see FIG. 1b, and in the bitstream generated by the Opus encoder, what is encoded prior to the encoded data of the current frame is in-band FEC data in the previous frame, so that the Opus encoder has a certain packet loss resistance. For the above-mentioned overall scheme of the new encoder, in-band FEC data is put into the padding portion, so that if the old terminal is the Opus encoder, the old terminal cannot analyze in-band FEC information from the bitstream generated by the new encoder, greatly reducing the packet loss resistance; when the network condition is poor, more freeze appears in the received audio signal, affecting the communication experience of the old terminal user.

In order to solve the above problem, when designing bitstreams of a new encoder based on the Opus encoder, a certain md bitstream of a previous frame is encoded into an output bitstream in an Opus coding in-band FEC manner (that is, when there is a previous media frame before the current media frame, obtaining at least two historical multiple description bitstreams of the previous media frame; selecting one historical multiple description bitstream from multiple description bitstreams of the previous media frame, wherein the selected historical multiple description bitstream is one of n−1 multiple description bitstreams except the first bitstream of the previous media frame; and encoding the selected historical multiple description bitstream into the forward error correction position of the target bitstream of the current media frame), and the Opus encoder of the old terminal will treat the bitstream as in-band FEC data to be processed, so that the packet loss resistance of the old terminal is recovered under the condition of ensuring the compatibility between the new encoder and the old encoder.

FIG. 4f is a schematic encoding flowchart for an Opus encoder provided in an embodiment of the present disclosure, and FIG. 4g is a schematic diagram of a bitstream structure for an Opus encoder provided in an embodiment of the present disclosure.

Referring to FIG. 4f and FIG. 4g, the scheme is basically the same as the above-mentioned overall scheme in the aspect of encoding process, and the bitstream is also divided into a compatible portion and a padding portion, except that the method for encoding a certain md bitstream of the previous frame and its position in the output bitstream are different from the overall scheme. That is, the previous media frame is obtained from the cache pool, and the corresponding one history multiple description bitstream is written into the in-band FEC data portion of the compatible portion of the target bitstream, i.e., the Opus in-band FEC data portion.

Taking the bitstream of the mth frame as an example, assuming that the compatible portion stores md_1 data of the mth frame and md_2 data of the (m−1)th frame (equivalently, Opus in-band FEC data), when the number of md bitstreams is greater than 2, the padding portion stores md_3 data of the (m−2)th frame, . . . , md_n data of the (m−n+1)th frame.

At the receiving end, the new terminal and the old terminal process the bitstreams sent by the new encoder differently, which are respectively introduced as follows:

For each received bitstream, it is analyzed as follows:
a. firstly, analyzing a frame header byte, to obtain related attributes of an audio frame, a flag bit indicating variable rate coding or not, and a flag bit indicating whether padding data is carried;
b. if it is determined that the bitstream caries padding data, analyzing a total length of the padding portion, namely a padding portion length, from a byte following the frame header byte;
c. taking out a certain md bitstream of the current frame carried by the compatible portion, according to the length of the whole bitstream and the total length of the padding portion, i.e., obtaining a first bitstream of a encoded data portion of the target bitstream (if an Opus encoder is based, a certain md bitstream of a previous frame carried by the compatible portion is also taken out), and positioning the first bitstream to an initial position of the padding portion (namely, determining the initial position of the padding portion of the target bitstream based on the bitstream length and the padding portion length);
d. analyzing a control byte of the padding portion, to obtain information such as the number n of the md bitstreams, a flag bit indicating bandwidth extension data or not, a flag bit indicating in-band FEC data or not, and an offset of the in-band FEC data, namely, obtaining an offset corresponding to the redundant coding information from the control byte of the target bitstream; and
e. sequentially taking out md bitstreams of previous n−1 (if the Opus encoder is based, the number is n−2) frames from the padding bitstreams (namely, when there is a second bitstream in the padding data portion of the target bitstream, obtaining the second bitstream of the padding data portion of the target bitstream), and if the flag bits of BWE and in-band FEC are true, continuously taking out bandwidth expansion and in-band FEC bitstreams of the current frame. Note that in the case of variable rate coding, the length of each bitstream needs to be analyzed first, and then the data of each bitstream is taken out according to the length.

According to the bitstream structure defined by the encoding end, for a data packet of the mth frame, a md_1 bitstream of the mth frame, a md_2 bitstream of the (m−1)th frame, . . . , a md_n bitstream of the (m−n+1)th frame, and an in-band FEC redundant coding bitstream of the (m-k)th frame (k>n−1) are carried; however, if a complete MDC decoding is to be performed on the mth frame signal, all the md bitstreams of the mth frame need to be taken, so that the receiving end needs to combine data of the current frame and some subsequent frames when decoding, which are divided into the following conditions.

FIG. 4h is a schematic decoding flowchart of a decoder according to an embodiment of the disclosure, referring to FIG. 4h:

1. Receiving bitstreams of the mth frame, the (m+1)th frame, the (m+2)th frame, . . . , the (m+n−1)th frame, namely, obtaininge multiple description bitstreams of the current media frame from subsequent bitstreams according to the number of the multiple description bitstreams. The mth frame bitstream comprises a md_1 bitstream of the mth frame, the (m+1)th frame bitstream comprises a md_2 bitstream of the mth frame, and so on, the (m+n−1)th frame bitstream comprises a md_n bitstream of the mth frame. In this case, all md bitstreams of the mth frame signal are equivalently received and are respectively analyzed out and sent to a multiple description decoder (namely, decoding according to the obtained multiple description bitstreams of the current media frame, to obtain the current media frame), so that complete MDC decoding can be achieved, and a high-quality output signal is obtained. If the bandwidth expansion data of the mth frame is analyzed from the bitstream of the mth frame, it is sent to a bandwidth expansion decoder, thereby further enhancing the quality of the MDC decoded output signal.

2. One or more of the bitstreams described in 1 (no more than n−1) are received. This means that only part of the md bitstreams of the mth frame is taken, complete MDC decoding cannot be achieved, and the quality of decoded output audio will be inferior to that of the complete MDC decoding; however, even if only one md bitstream is received, the decoded audio quality is also acceptable and basically does not affect the user experience, and if more md bitstreams are received, the audio quality will be improved. In addition, if the bitstream of the mth frame is received and it is analyzed that the bitstream carries the bandwidth expansion data of the mth frame, the data is sent to a bandwidth expansion decoder (namely, obtaining bandwidth expansion data carried in the padding data portion of the target bitstream; obtaining the current media frame based on the bandwidth expansion data), thereby further enhancing the quality of the output signal.

3. None of the bitstreams described in 1 was received, i.e. at least two packets were lost consecutively.

a. If the bitstream of the (m+k)th frame (k>n−1) is received and it is analyzed from the bitstream that it carries in-band FEC data of the mth frame, the data can be used for decoding the mth frame signal, namely, if the current multiple description bitstream of the current media frame is not obtained, redundant coding information of the current media frame is obtained from the bitstream carrying the redundant coding information of the current media frame; the redundant coding information is decoded, and the output audio quality is inferior to that of the normal MDC decoding, but the quality is acceptable, and the audio freeze phenomenon will not occur, and the communication experience of the user is not influenced basically.

b. If the bitstream of the (m+k)th frame is not received or the bitstream of the (m+k)th frame does not carry in-band FEC data of the mth frame, no data can be provided to a decoder for decoding the signal of the mth frame, the decoder will call a self-developed Packet Loss Concealment (PLC) algorithm to recover the audio signal, and at this time, an audio freeze phenomenon may occur. This occurs only when continuous packet loss >=n frames, and the in-band FEC frame corresponding to the current frame is also lost, but the occurrence is of low probability.

The decoding scheme of the old terminal is described as follows:

FIG. 4i is a schematic decoding diagram provided in an embodiment of the disclosure, and referring to FIG. 4i, for a received bitstream sent by the new encoder, an analysis process is as follows:
1. firstly, analyzing a frame header byte, and obtaining related attributes of an audio frame and a flag bit indicating whether padding data is carried;
2. if it is determined that the bitstream carries the padding data, analyzing a total length of the padding portion from a byte following the frame header byte;
3. determining a bitstream length of the compatible portion according to the length of the whole bitstream and the total length of the padding portion, taking out a bitstream in the compatible portion, sending it into a core decoder for decoding, and filtering out the bitstream in the padding portion.

The following takes the Opus encoder as an example to describe a decoding method of the old terminal when packet loss does not occur or occurs:
1. if a bitstream of the current frame is received, directly analyzing the bitstream in the compatible portion, and sending it into a decoder to decode and output the audio signal of the current frame;
2. if the bitstream of the current frame is not received:
a. if a bitstream of the next frame is received and it is analyzed that the bitstream carries in-band FEC data of the current frame, analyzing the bitstream in the compatible portion of the next frame, and sending it to a decoder to decode and output the audio signal of the current frame in an in-band FEC manner (note: if the old terminal is not an Opus encoder, a certain md bitstream of the new encoder will not be encoded in the in-band FEC manner, and the processing logic described in the step will not appear);
b. if the bitstream of the next frame is not received or the bitstream of the next frame does not carry the in-band FEC data of the current frame, decoding according to the processing logic of the decoder for packet loss.

The above processing flow is an inherent decoding flow of the old terminal, without making adaptive modifications to the new encoder, and a normal signal can be decoded and outputted after obtaining the bitstream of the new encoder, which indicates that the bitstream of the new encoder is completely compatible with the old terminal.

The following is an exemplary description of the new encoder. Let the number of multiple description coding bitstreams (namely, the current multiple description bitstreams) be 2, the encoding flow is as follows:
1. applying an Opus encoder-based multiple description coding algorithm to an input signal frame (namely, a current media frame), to generate two multiple description bitstreams md_1 and md_2 (namely, current multiple description bitstreams);
2. processing the input signal frame by using enhanced encoder BWE and in-band FEC technologies, to obtain relevant coding flags (namely coding identification information) and data (namely encoded data);
3. generating a coded bitstream, namely a target bitstream:
a. generating a frame header byte, wherein the attributes of the audio frame and the flag indicating variable rate coding or not are configured by the user, and the flag indicating whether padding data is carried is set to true;
b. selecting one from the two md bitstreams as the encoded data of the current frame to be stored in an output bitstream, putting the other md bitstream into a bitstream cache pool, taking a corresponding md bitstream of the previous frame out of the cache pool, and encoding it into the output bitstream according to an Opus coded in-band FEC manner;
c. generating a control byte of the padding data according to the number of md bitstreams, and flags indicating whether BWE and in-band FEC are encoded; if the flag for encoding the BWE is true, after storing the BWE encoded data in the control byte, also storing the in-band FEC data in sequence in the same manner; and if the flag for variable rate is true, inserting bytes indicating lengths of the BWE and in-band FEC data preceding the BWE and in-band FEC data;
d. calculating a total length of the padding portion, encoding the length, and inserting the encoded data after the frame header byte.

FIG. 4j is a schematic packing diagram provided in an embodiment of the disclosure, and referring to FIG. 4j, md_1 is selected as the encoded data of the current frame, and md_2 is selected as the in-band FEC data of Opus. FIG. 4k is a schematic diagram of a bitstream structure provided in an embodiment of the present disclosure, and referring to FIG. 4k, the data padding portion of the target bitstream does not comprise a second bitstream. The compatible portion comprises historical multiple description bitstreams of the previous frame.

Let the number of multiple description coding bitstreams be 3, and the encoding flow is as follows:
1. applying an Opus encoder-based multiple description coding algorithm to an input signal frame, to generate three multiple description bitstreams md_1, md_2, md_3;
2. processing the input signal frame by using enhanced encoder BWE and in-band FEC technologies, to obtain relevant coding flags and data;
3. generating a coded bitstream:
a. generating a frame header byte, wherein the attributes of the audio frame and the flag indicating variable rate coding or not are configured by the user, and the flag indicating whether padding data is carried is set to true;
b. selecting one from the three md bitstreams as the encoded data of the current frame to be stored in an output bitstream, putting the other two md bitstreams into a bitstream cache pool, taking a md bitstream of the previous frame out of the cache pool, and encoding it into the output bitstream according to an Opus coded in-band FEC manner;
c. generating a control byte of the padding data according to the number of md bitstreams, and flags indicating whether BWE and in-band FEC are encoded; after one md bitstream (the numbering is different from the numbering of the md bitstream in b) of the previous 2 frames is taken out of the cache pool and stored in the control byte, if the flag for encoding the BWE is true, after storing the BWE encoded data in the md bitstream, also storing the in-band FEC data in sequence in the same manner; and if the flag for variable rate is true, inserting bytes indicating lengths of the md bitstream, the BWE and in-band FEC data preceding the md bitstream, the BWE and in-band FEC data;
d. calculating a total length of the padding portion, encoding the length, and inserting the encoded data after the frame header byte.

FIG. 4l is another schematic packing diagram provided in an embodiment of the disclosure, and referring to FIG. 4l, md_1 is selected as the encoded data of the current frame, md_2 is selected as the in-band FEC data of Opus, and md_3 is selected as the padding data.

FIG. 4m is a schematic diagram of yet another bitstream structure provided in an embodiment of the present disclosure, and referring to FIG. 4m, the padding data portion includes historical multiple description bitstreams of historical media frames, and the compatible portion includes historical multiple description bitstreams of a previous frame.

For more multiple description bitstreams, the new encoder can also support and process the same as the number 3, except that the padding portion stores more md bitstreams, and specific embodiments are not introduced one by one here.

In addition to the Opus encoder, the new encoding method also supports other encoders with padding data fields, except that the other encoders may not encode in-band FEC information in the bitstream like Opus, and thus, for other encoders, only one md bitstream may be encoded into a portion compatible with the core encoder, such as the set encoder, and all other md bitstreams may be encoded into a padding portion, such as a padding portion of a different bitstream. Other encoders include, but are not limited to: EVS, USAC, H.264 or H.265.

The present disclosure may not use the enhanced encoder techniques, and may also use techniques with other enhanced encoders added, in addition to the BWE and in-band FEC techniques.

FIG. 5 is a schematic structural diagram of an encoding apparatus provided in an embodiment of the present disclosure, and as shown in FIG. 5, the encoding apparatus comprises:
an encoding module 510, configured to encode a current media frame into at least two bitstreams, for example, execute the step S110;
an generating module 530, configured to generate a target bitstream of the current media frame, for example, execute the step S130.

The target bitstream comprises encoded data and padding data, and the encoded data comprises a first bitstream. The first bitstream is one of the at least two bitstreams, and the padding data comprises at least one of bitstream(s) other than the first bitstream, bitstreams of historical media frames, or enhanced coding information of the current media frame.

According to the technical solution provided by the embodiment of the disclosure, the current media frame is encoded into at least two bitstreams, and then the target bitstream is generated, wherein the bitstream format of the target bitstream is the same as that of the set encoder, and the generated target bitstreams all can be decoded by the set decoder corresponding to the set encoder. The target bitstream can be directly transmitted to a receiving end, without additional calculation complexity and end-to-end delay caused by transcoding, and without additional degradation of communication quality caused by fallback, realizing the compatibility between the new encoder that executes the encoding method of the present disclosure and the set encoder.

By including, in the padding data portion of the target bitstream, one or more bitstreams, bitstreams of historical media frames, and/or enhanced coding information of the current media frame, the decoding quality and packet loss resistance are improved. Specifically, the target bitstream obtained by the encoding comprises a bitstream of the current media frame, the data padding portion comprises the current bitstream, historical bitstreams of historical media frames and/or enhanced coding information of the current media frame, a plurality of bitstreams of one media frame can be distributed in different bitstreams, so that the media frame can be decoded by decoding any one bitstream, improving the packet loss resistance of the encoder.

The encoder provided by the embodiment of the disclosure can execute the encoding method provided by any embodiment of the disclosure, and has corresponding functional modules and beneficial effects of the executed method.

In one embodiment, the encoding apparatus further comprises a determining module configured to: when there is a historical media frame before the current media frame, determining a second bitstream, wherein the second bitstream is one of at least two bitstreams of the historical media frame, and the number of the historical media frame is at least one; wherein the target bitstream also comprises the second bitstream.

In an embodiment, the determining module is specifically configured to: when there are historical media frames before the current media frame, for each of previous M historical media frames of the current media frame, selecting a bitstream from at least two bitstreams of the historical media frame, wherein the bitstream selected each time for the historical media frame is different; and determining the selected historical bitstream as the second bitstream.

In an embodiment, the determining module is specifically configured to: for each of the previous M historical media frames of the current media frame, obtaining unselected historical bitstreams of the historical media frame from a cache pool; and selecting one historical bitstream from the unselected historical bitstreams.

In an embodiment, each of the historical bitstreams is sequentially read according to a set sequence, the cache pool sets different cache regions according to different frame numbers required for caching the bitstreams, the cached bitstreams include bitstreams cached by the current media frame and the historical media frames, the bitstreams cached by the current media frame include bitstreams of the at least two current bitstreams except the first bitstream, and a caching mode of the bitstreams cached by the historical media frames is the same as a caching mode of the bitstreams cached by the current media frame.

In an embodiment, the generating module 530 is specifically configured to: encode the first bitstream to a encoded data portion of the target bitstream; and encode the second bitstream and control information to a padding data portion of the target bitstream, wherein the control information includes the number of bitstreams included in the target bitstream, and the target bitstream includes a plurality of bitstreams, including the first bitstream and the second bitstream.

In an embodiment, the generating module 530 is specifically configured to: when there is a previous media frame before the current media frame, obtain at least two historical bitstreams of the previous media frame;
select a historical bitstream from the bitstreams of the previous media frame, wherein the selected historical bitstream is one of the bitstreams except the first bitstream of the previous media frame; and encode the selected historical bitstream to a forward error correction position of a target bitstream of the current media frame.

In one embodiment, the encoding apparatus further comprises a encoded data encoding module, configured to: encode the current media frame by adopting a set coding technique, to obtain encoded data. Correspondingly, the generating a target bitstream of the current media frame, comprises: encoding the encoded data and coding identification information corresponding to the encoded data to a padding data portion of the target bitstream, wherein the coding identification information indicates whether the encoded data is carried in the target bitstream, and the enhanced coding information comprises the encoded data and the coding identification information.

In one embodiment, the set coding technique includes an in-band Forward Error Correction (FEC) technique, the in-band FEC technique corresponds to an offset k, which indicates what is corresponded is redundant coding information of a previous kth frame of the current media frame, the control information included in the padding data portion includes the coding identification information and the offset, the control information included in the padding data portion is encoded in a control byte of the padding data portion, and the included encoded data is encoded after the control byte.

It should be noted that, the units and modules included in the apparatus are merely divided according to functional logic, but are not limited to the above division as long as the corresponding functions can be implemented; in addition, specific names of the functional units are also only used for distinguishing one functional unit from another, and are not used for limiting the protection scope of the embodiments of the present disclosure.

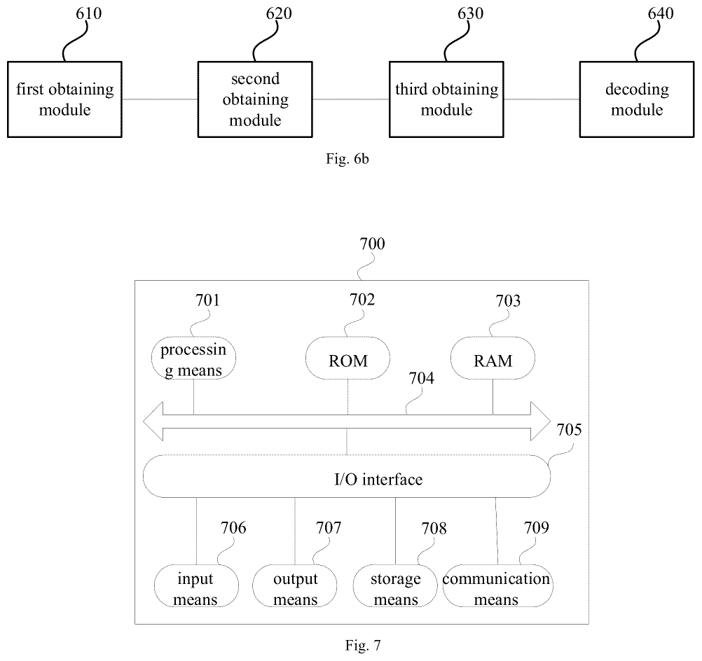

FIG. 6a is a schematic structural diagram of a decoding apparatus provided in an embodiment of the present disclosure, comprising: a first obtaining module 610 configured to obtain a target bitstream of a current media frame, for example, execute the step S310. The target bitstream is, for example, a bitstream generated after encoding the current media frame. The target bitstream comprises encoded data and padding data. In some embodiments, the target bitstream further includes: in-band forward error correction data which comprises one of at least two bitstreams of a previous historical media frame of the current media frame. For example, the target bitstream is an Opus bitstream.

The encoded data comprises a first bitstream, the first bitstream is one of at least two bitstreams of the current media frame, and the padding data comprises at least one of bitstream(s) other than the first bitstream, bitstreams of historical media frames, and enhanced coding information of the current media frame.

In some embodiments, the at least two bitstreams are multiple description bitstreams. The padding data comprises one or more current multiple description bitstreams of a current media frame, historical multiple description bitstreams of a historical media frame and/or enhanced coding information of the current media frame, and the first bitstream is one current multiple description bitstream of at least two current multiple description bitstreams of the current media frame.

As shown in FIG. 6a, the decoding apparatus further comprises a decoding module 640, configured to decode the obtained target bitstream, to obtain the current media frame.

FIG. 6b is a schematic structural diagram of another decoding apparatus provided in an embodiment of the present disclosure. FIG. 6b differs from FIG. 6a in further comprising: a second obtaining module 620, configured to obtain control information in the target bitstream, wherein the control information indicates a number of all multiple description bitstreams included in the target bitstream, for example, the step S320 is executed; and a third obtaining module 630, configured to obtain multiple description bitstreams of the current media frame from subsequent bitstreams, according to the number of the multiple description bitstreams, for example, execute the step S330.

According to the technical solution provided by the embodiment of the disclosure, the target bitstream can be decoded by the decoding method, and the target bitstream can be obtained by the encoding of the encoding method provided by the embodiment of the disclosure. When the target bitstream is decoded, candidate bitstreams are obtained based on the indication of the control information during decoding, so that a plurality of current multiple description bitstreams can be obtained, improving the decoding quality.

The decoder provided by the embodiment of the disclosure can execute the decoding method provided by any embodiment of the disclosure, and has corresponding functional modules and beneficial effects of the executed method.

In one embodiment, the number of the multiple description bitstreams is n, the subsequent bitstreams are n−1 frames following the current media frame, and the number of the obtained multiple description bitstreams of the current media frame is 0 to n−1.

In an embodiment, the decoding apparatus further comprises a fourth obtaining module, configured to: if the current multiple description bitstream of the current media frame is not obtained, obtain redundant coding information of the current media frame from a bitstream carrying the redundant coding information of the current media frame; and decode the redundant coding information.

In an embodiment, the bitstream carrying the redundant coding information of the current media frame is a target bitstream of a kth frame after the target bitstream of the current media frame.

In an embodiment, the fourth obtaining module is specifically configured to: obtain an offset corresponding to the redundant coding information from control information in a control byte of the target bitstream; obtain a bitstream carrying the redundant coding information of the current media frame, wherein the bitstream is a bitstream offset by the offset after the target bitstream; and obtain the redundant coding information of the current media frame in the bitstream.

In one embodiment, the redundant coding information is carried in a padding data portion of the corresponding target bitstream.

In one embodiment, the decode module 640 comprises: an input unit, configured to input the multiple description bitstream of the current media frame into a multiple description decoder to obtain decoded data; and an obtaining unit, configured to obtain the current media frame based on the decoded data.

In an embodiment, the obtaining unit is specifically configured to: obtain bandwidth expansion data carried by a padding data portion of the target bitstream; and process the decoded data based on the bandwidth extension data to obtain the current media frame.

In an embodiment, the second obtaining module 620 is specifically configured to: analyze a bitstream length and a padding portion length of the target bitstream; determine an initial position of the padding portion of the target bitstream based on the bitstream length and the padding portion length; and analyze the padding portion based on the initial position, to obtain the control information.

It should be noted that, the units and modules included in the apparatus are merely divided according to functional logic, but are not limited to the above division as long as the corresponding functions can be implemented; in addition, specific names of the functional units are also only used for distinguishing one functional unit from another, and are not used for limiting the protection scope of the embodiments of the present disclosure.

FIG. 7 is a schematic structural diagram of an electronic device according to an embodiment of the present disclosure. Referring now to FIG. 7, shown is a schematic block diagram of an electronic device (e.g., a terminal device or server in FIG. 7) 700 suitable for implementing the embodiments of the present disclosure.

The electronic device 700 comprises: one or more processing means (processor) 701; and one or more storage means (memory) 708 for storing one or more programs which, when executed by the one or more processing means 701, cause the one or more processing means 701 to implement the encoding method and/or the decoding method according to the embodiments of the present disclosure.

The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), a vehicle terminal (e.g., a vehicle navigation terminal), and the like, and a fixed terminal such as a digital TV, a desktop computer, and the like. The electronic device shown in FIG. 7 is only an example, and should not bring any limitation to the functions and the scope of use of the embodiments of the present disclosure.

An embodiment of the disclosure provides an encoder that executes the encoding method provided by the disclosure. An embodiment of the disclosure also provides a decoder that executes the decoding method provided by the disclosure. The encoder has functional modules and beneficial effects corresponding to the encoding method of the disclosure. The decoder has functional modules and beneficial effects corresponding to the decoding method of the disclosure.

As shown in FIG. 7, the electronic device 700 may include a processing means (e.g., central processing unit, graphics processor, etc.) 701 that may perform various appropriate actions and processes in accordance with a program stored in a Read Only Memory (ROM) 702 or a program loaded from a storage means 708 into a Random Access Memory (RAM) 703. In the RAM 703, various programs and data necessary for the operation of the electronic device 700 are also stored. The processing means 701, the ROM 702, and the RAM 703 are connected to each other via a bus 704. An input/output (I/O) interface 705 is also connected to the bus 704.

Generally, the following means may be connected to the I/O interface 705: input means 706 including, for example, a touch screen, touch pad, keyboard, mouse, camera, microphone, accelerometer, gyroscope, or the like; an output means 707 including, for example, a Liquid Crystal Display (LCD), a speaker, a vibrator, and the like; a storage means 708, including, for example, magnetic tape, hard disk, etc.; and a communication means 709. The communication means 709 may allow the electronic device 700 to communicate with other means, wireless or wired, to exchange data. While FIG. 7 illustrates the electronic device 700 having various means, it is to be understood that not all illustrated means are required to be implemented or provided. More or fewer means may be alternatively implemented or provided.

In particular, the processes described above with reference to the flow diagrams may be implemented as computer software programs, according to the embodiments of the present disclosure. For example, the embodiments of the present disclosure include a computer program product comprising a computer program carried on a non-transitory computer readable medium, the computer program containing program code for performing the method illustrated by the flowchart. In such an embodiment, the computer program may be downloaded and installed from a network via the communication means 709, or may be installed from the storage means 708, or may be installed from the ROM 702. The computer program, when executed by the processing means 701, performs the above functions defined in the methods of the embodiments of the present disclosure.

The names of messages or information exchanged between devices in the embodiments of the present disclosure are for illustrative purposes only, and are not intended to limit the scope of the messages or information.

The electronic device provided by the embodiment of the present disclosure and the encoding method and/or decoding method provided by the above embodiments belong to the same inventive concept, and technical details that are not described in detail in the embodiment can be referred to the above embodiments, and the embodiment has the same beneficial effects as the above embodiments.

An embodiment of the present disclosure provides a computer storage medium having thereon stored a computer program which, when executed by a processor, implements the encoding method and/or the decoding method provided by the above embodiments.

It should be noted that the computer readable medium of the present disclosure may be a computer readable signal medium or a computer readable storage medium or any combination of the two.

The computer storage medium may be a storage medium for computer-executable instructions which, when executed by a computer processor, performs the method as provided by the present disclosure.

The computer readable storage medium may be, for example, but is not limited to: an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium that can contain, or store a program for use by or in connection with an instruction execution system, apparatus, or device. In contrast, in the present disclosure, the computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. The computer readable signal medium may be any computer readable medium other than the computer readable storage medium and can communicate, propagate, or transport a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the clients, servers may communicate using any currently known or future developed network protocol, such as HTTP (HyperText Transfer Protocol), and may be interconnected with any form or medium of digital data communication (e.g., a communication network). Examples of communication networks include a local area network (“LAN”), a wide area network (“WAN”), an internet (e.g., the Internet), and a peer-to-peer network (e.g., ad hoc peer-to-peer network), as well as any currently known or future developed network.

The computer readable medium may be embodied in the electronic device; or may be separate and not assembled into the electronic device.

The computer readable medium carries one or more programs which, when executed by the electronic device, cause the electronic device to: encode a current media frame into at least two current multiple description bitstreams; determine a first bitstream that is one of the at least two current multiple description bitstreams; and generate a target bitstream of the current media frame, wherein the target bitstream comprise the first bitstream, the target bitstream comprises a padding data portion, and the padding data portion comprises one or more of the current multiple description bitstreams, historical multiple description bitstreams of historical media frames, and/or enhanced coding information of the current media frame.

Alternatively, the computer readable medium carries one or more programs which, when executed by the electronic device, cause the electronic device to: obtain a first bitstream of a target bitstream, wherein the target bitstream is a bitstream generated by encoding a current media frame, the target bitstream comprises a padding data portion, the padding data portion comprises one or more current multiple description bitstreams of the current media frame, historical multiple description bitstreams of historical media frames, and/or enhanced coding information of the current media frame, and the first bitstream is one of at least two current multiple description bitstreams of the current media frame; obtain control information in the target bitstream, wherein the control information indicates the number of all multiple description bitstreams included in the target bitstream; according to the number of the multiple description bitstreams, obtain multiple description bitstreams of the current media frame from bitstreams of subsequent frames; and decode according to the obtained multiple description bitstreams of the current media frame, to obtain the current media frame.

Computer program code for carrying out operations of the present disclosure may be written in one or more programming languages or any combination thereof, including but not limited to an object oriented programming language, such as Java, Smalltalk, C++, including conventional procedural programming languages, such as “C” language or similar programming languages. The program code may be executed entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a Local Area Network (LAN) or a Wide Area Network (WAN), or may be connected to an external computer (for example, through the Internet using an Internet service provider).

The flow and block diagrams in the figures illustrate the architecture, functionality, and operation of possible implementations of systems, methods and computer program products according to various embodiments of the present disclosure. In this regard, each block in the flow or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in a reverse order, depending upon the functionality involved. It will also be noted that each block of the block diagrams and/or flow diagrams, and combinations of blocks in the block diagrams and/or flow diagrams, can be implemented by special purpose hardware-based systems that perform the specified functions or actions, or combinations of special purpose hardware and computer instructions.

The modules or units described in the embodiments of the present disclosure may be implemented by software or hardware. The name of a module or unit does not in some cases constitute a limitation of the unit itself, for example, the first obtaining module may also be described as a “first bitstream obtaining module”.

The functions described herein above may be performed, at least in part, by one or more hardware logic components. For example, without limitation, exemplary types of hardware logic components that may be used include: field Programmable Gate Array (FPGA), Application Specific Integrated Circuit (ASIC), Application Specific Standard Product (ASSP), system on a chip (SOC), Complex Programmable Logic Device (CPLD), and the like.

In the context of this disclosure, the machine-readable medium may be a tangible medium that can contain, or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The foregoing description is merely illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing may be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

What is claimed is:

1. An encoding method, comprising:
encoding a current media frame into at least two bitstreams; and
generating a target bitstream of the current media frame, wherein the target bitstream comprises encoded data and padding data, the encoded data comprises a first bitstream, the first bitstream is one of the at least two bitstreams, and the padding data comprises at least one of bitstream(s) other than the first bitstream, bitstreams of historical media frames, or enhanced coding information of the current media frame.

2. The encoding method according to claim 1, wherein the bitstreams of the historical media frames comprise: one bitstream of at least two bitstreams of each historical media frame in previous M historical media frames of the current media frame, wherein the bitstreams of the historical media frames comprise a kth bitstream of an ith historical media frame, where M is a positive integer greater than or equal to 1, i is a positive integer less than or equal to M, k is a positive integer less than or equal to n, and n is a number of bitstreams and is a positive integer greater than or equal to 2.

3. The encoding method according to claim 2, wherein the first bitstream is a jth bitstream of the current media frame, where j is a positive integer less than or equal to n, and j≠k.

4. The encoding method according to claim 3, wherein M=n−1.

5. The encoding method according to claim 3, wherein the bitstreams of the historical media frames further comprise a lth bitstream of a mth historical media frame, where m≠i, l≠j≠k, m is a positive integer less than or equal to M, and l is a positive integer less than or equal to n.

6. The encoding method according to claim 5, wherein i=k.

7. The encoding method according to claim 1, wherein the padding data further comprises: control information for indicating a number of bitstreams comprised in the target bitstream.

8. The encoding method according to claim 1, wherein the target bitstream further comprises: in-band forward error correction data, comprising one of at least two bitstreams of a previous historical media frame of the current media frame.

9. The encoding method according to claim 1, wherein the padding data further comprises: control information for indicating whether the target bitstream carries enhanced coding information.

10. The encoding method according to claim 1, wherein the enhanced coding information comprises at least one of bandwidth extension coding information, or redundant coding information.

11. The encoding method according to claim 10, wherein the redundant coding information comprises: in-band forward error correction coding information, comprising one of at least two bitstreams of a historical media frame of the current media frame.

12. The encoding method according to claim 1, wherein the at least two bitstreams are multiple description bitstreams.

13. The encoding method according to claim 1, wherein the target bitstream is an Opus bitstream.

14. A decoding method, comprising:
obtaining a target bitstream of a current media frame, wherein the target bitstream comprises encoded data and padding data, the encoded data comprises a first bitstream, the first bitstream is one of at least two bitstreams of the current media frame, and the padding data comprises at least one of bitstream(s) other than the first bitstream, bitstreams of historical media frames, or enhanced coding information of the current media frame; and
decoding the target bitstream, to obtain the current media frame.

15. An electronic device, comprising:
one or more processors; and
one or more memories configured to store one or more programs, which when executed by the one or more processors, cause the one or more processors to implement the encoding method according to claim 1.

16. The electronic device according to claim 15, wherein the bitstreams of the historical media frames comprise: one bitstream of at least two bitstreams of each historical media frame in previous M historical media frames of the current media frame, wherein the bitstreams of the historical media frames comprise a kth bitstream of an ith historical media frame, where M is a positive integer greater than or equal to 1, i is a positive integer less than or equal to M, k is a positive integer less than or equal to n, and n is a number of bitstreams and is a positive integer greater than or equal to 2.

17. An electronic device, comprising:
one or more processors; and
one or more memories configured to store one or more programs, which when executed by the one or more processors, cause the one or more processors to implement the decoding method according to claim 14.

18. A non-transitory storage medium comprising computer-executable instructions, which when executed by one or more computer processors, perform the encoding method according to claim 1.

19. The non-transitory storage medium according to claim 18, wherein the bitstreams of the historical media frames comprise: one bitstream of at least two bitstreams of each historical media frame in previous M historical media frames of the current media frame, wherein the bitstreams of the historical media frames comprise a kth bitstream of an ith historical media frame, where M is a positive integer greater than or equal to 1, i is a positive integer less than or equal to M, k is a positive integer less than or equal to n, and n is a number of bitstreams and is a positive integer greater than or equal to 2.

20. A non-transitory storage medium comprising computer-executable instructions, which when executed by one or more computer processors, perform the decoding method according to claim 14.
